(19) United States
(12) Patent Application Publication
(10) Pub. No.: US 2010/0179674 A1
(43) Pub. Date: Jul. 15, 2010

(54) UNIVERSAL MUSIC PRODUCTION SYSTEM WITH MULTIPLE MODES OF OPERATION

(75) Inventors: JOEL DAVID WILLARD, AUSTIN, TX (US); MATTHEW ERNEST PRESLEY, AUSTIN, TX (US); VICTOR WING TONG WONG, AUSTIN, TX (US); FREDERICK ARTHUR SMITH, AUSTIN, TX (US)

Correspondence Address: HOWISON & ARNOTT, L.L.P, P.O. BOX 741715, DALLAS, TX, 75374-1715, US

(73) Assignee: OPEN LABS, Austin, TX (US)

(21) Appl. No.: 12/688,673

(22) Filed: Jan. 15, 2010

Related U.S. Application Data
(60) Provisional application No. 61/144,806, filed on Jan. 15, 2009.

(51) Int. Cl. G06F 3/048; G06F 17/00

(52) U.S. Cl. 700/94; 715/771

(57) ABSTRACT

A universal music production system and related software is provided that enables an open source microprocessor and its operating system to provide ergonomic and user friendly control of editing audio processing configurations of one or more systems, instruments or synthesizers in a music studio edit mode environment and then utilize the studio edit mode song/performance configurations in a live mode performance environment that disables the user from certain studio edit mode functions. When in edit mode, the universal music production system may check for illogical sound and effect plug-in order in a user created signal/sound stream and automatically stop its creation or warn the user of the illogical order. User created virtual controls can be displayed on a touch sensitive display screen enabling a user to control predetermined sound parameters easily during a live performance. Also, reconfiguration of any or all of the sound signal chains for various sound tracks can be accomplished substantially instantaneously via VST instrument and effect plug-ins.

### CROSS-REFERENCE TO RELATED APPLICATIONS

This application claims the benefit of U.S. Provisional Application for Patent Ser. No. 61/144,806, filed on Jan. 15, 2009, and entitled, “UNIVERSAL MUSIC PRODUCTION SYSTEM,” which is incorporated herein by reference.

### TECHNICAL FIELD OF THE INVENTION

The present invention generally relates to the control of audio processing and control systems and equipment and specifically to a means for the control of virtual or physical audio synthesizers and processors in a live environment. The system disclosed provides novel hardware and software configurations of such systems to allow a user increased real time flexibility and ergonomic control as compared within prior audio processing and control systems for live environments.

### BACKGROUND OF THE INVENTION

It is well known to control the production of music through electronics and software. Devices such as synthesizers, sequencers and digital signal processors (DSPs) are commonly used to create, emulate and control all aspects of the music production process.

Although the use of physical instruments such as pianos and guitars is still common place, it is becoming increasingly common that the sounds produced by those physical instruments are also available from a virtual instrument or software running either on dedicated synthesizer hardware or on a general purpose personal computer or PC. In addition, many new sounds that cannot be generated by an actual physical instrument are also created by such software or virtual instruments. These virtual instruments do not have to exist within the limitations of the analog or the hardware world and thus present almost limitless creative opportunities for musicians. The virtualization of the music creation process isn't limited to virtual instruments, but also contains many audio processing and control components now available as virtual or software driven equivalents. For example, such traditional hardware devices as filters, equalizers, audio mixers, sample rate converters and sounds effects devices are all available as virtual, software based, devices that may also run on a general purpose PC.

These software based virtual devices for creating and processing music and audio signals are commonly available from software vendors as software modules or components with a standardized Application Programmer Interface (API) connection such that a number of such modules may be loaded and run simultaneously on a single PC and be connected together via software connections or ‘pins’ so as to emulate an audio signal chain familiar to users of audio and music processing hardware devices. For example, a virtual synthesizer module may have its output connected to a virtual filter module, the output of the virtual filter module may then connect to a virtual equalizer module, then to a virtual reverberation unit and finally to a virtual audio mixer module through software connections in a manner that mimics the way that physical devices may be connected using audio signal cables. However, an advantage of the virtual module system over the physical devices is that such connections and configurations can be created, recorded and recalled giving the operator some flexibility in the topology of such connections and the ability to switch between different topologies with no requirement for the physical plugging and unplugging of cables.

A number of software module systems have been developed around such architecture. The software module systems provide a common API that remains constant irrespective of the specific features provided by the modules. The modules can form an audio signal chain as described above. Software modules or components that share a common API are commonly called as ‘plug-ins’.

There are a number of plug-in modular system APIs offered but two that are commonly used are the Virtual Studio Technology (VST) API developed by Steinberg Media Technologies GmbH and the DirectX API from Microsoft. Both these plug-in APIs provide open standard architectures for connecting audio modules such as synthesizers and effect modules to audio mixers, editors and recording systems and are designed to run on personal computers. Both architectures are available to third party developers in a freely licensed Software Development Kit (SDK) from their respective authors.

The availability and popularity of such APIs has encouraged the marketplace to develop a plethora of diverse modules all following the tenets of the API. This, in turn, has created a need for software programs to manage, oversee and link these plug-ins in a single host application and provide the user with a range of operational controls to load, configure, connect and operate a wide range of plug-ins simultaneously. Such host applications should seek to hide the complexity of the API from the user and instead present a common, unified user interface such that all the plug-ins cooperate and are controllable within the host application so that the system behaves as a single multi-faceted device.

In the past, such prior art host applications specifically targeted the needs of the home-hobbyist and the studio recording and editing needs of music industry. Prior host applications operated in a cumbersome, complex manner that made real-time plug-in sound or effect changes to a recording track or signal chain a relatively slow and non-ergonomic experience that is not conducive to implementation in live show or live performance environments or situations. Prior art host programs may often be extremely sophisticated but lack the accessibility and fluidity of user control that is needed when using such a system in a live performance or environment where the performer must make changes or reconfigurations to the audio system within a song, between songs or randomly during a performance. Consequently there is a need for a host software system, which provides both the detailed and accurate control required in off-line and studio audio processing and music production while at the same time also provides real-time, specific functionality in an ergonomic manner that enables and facilitates a user to provide a similar level of detailed and accurate audio control during a live real-time performance.

### SUMMARY OF THE INVENTION

Embodiments of an invention provide a music production system having a graphic user interface (GUI) display data processing circuitry that comprises a microprocessor with the data processing circuitry adapted to be electrically coupled to the graphic user display. The exemplary music production system further comprises an input device adapted to be electrically coupled to the data processing circuit. A memory storage is also electrically coupled to the data processing circuitry. The memory storage comprises host software, a plurality of VST, Direct X, or Audio Unit (AU) API plug-ins and a database. A plurality of instructions are also included, wherein at least a portion of the plurality of instructions are storable in the memory storage as part of the host program and the plurality of VST, Direct X, or AU API plug-ins. The plurality of instructions are configured to cause the data processing circuitry to perform the steps of: responding to a user selectable live mode/edit mode control button by setting the music production system to operate in a live mode or in an edit mode; if the music production system is set to operate in the edit mode, then accepting user input, via the input device, to edit a set list, edit a preset, edit a track, edit a rack, edit a signal chain, create a live control object, or learn a user selected parameter to a user selected hardware or user selected live control object; if the music production system is set to live mode, then accepting user input, via the input device, to initiate or adjust a live mode function, but not accepting or enabling user input that causes the data processing circuitry to perform a set list add/delete function, a preset add/delete edit function, a track add/delete function, a rack add/delete function, a plug-in add/delete function, a signal chain add/delete function or a live control object create function.

Embodiments of the music production system may have as an input device or devices, a touch sensitive surface on the GUI display, a keyboard, a pointer device, and/or various types of hardware MIDI controllers.

When an exemplary music production system is set in edit mode, the plurality of instructions may be further configured to cause the data processing circuitry to perform a learn operation. The learn operation comprises: responding to the user's selection of a learn control button, or an equivalent of selecting a learn control button, by placing the music production system into the learn mode; highlighting a first parameter selected by the user; receiving a MIDI controller command (CC) resulting from a user initiated movement or selection of a first hardware controller or a virtual movement or selection of a first live control object, wherein the live control object is displayed on the GUI display; latching changes in a value of the user selected parameter to a position or movement variation of the first selected hardware controller or the first selected live control object; and providing a visual indication that the selected parameter has been learned to the first selected hardware controller or to the first selected live control object.

Additional embodiments provide a music production system wherein the learn operation further comprises nesting learned live control objects such that one live control object may be automatically modulated or automatically modulate another live control object prior to controlling the parameter of an instrument or effect plug-in.

Additionally, embodiments of an exemplary music production system, when operating in live mode, are further configured by the host software instructions to cause the data processing circuitry to perform a soft takeover operation. The soft take over operation comprises responding to a user's selection of a first preset by configuring a first track, a first rack, a first plug-in, a first signal chain and a first hardware controller that is learned to a first parameter of the first plug-in in accordance with first preset data stored in the database. A comparison of an initial setting for the first parameter is made with respect to the initial setting/physical position of the first hardware controller. If the initial setting of the first parameter does not match with the initial setting/physical position of the first hardware controller then, disallowing signals received from the first hardware controller to effect adjustment of the first parameter until after the first hardware controller is moved such that the initial setting/physical position of the first hardware controller is momentarily equal to the initial setting of the first parameter.

In embodiments of the invention, a method of creating a keyboard split is provided. The method of creating a keyboard split may be for an ivory keyboard interface such that sections of the ivory keyboard interface are assigned to interact with different VST, Direct X or Audio Unit (AU) plug-ins. An exemplary method comprises displaying a signal chain graphic user interface (GUI) wherein the signal chain GUI comprises a first signal chain routing that includes a first virtual instrument plug-in and a first ivory keyboard GUI. The first ivory keyboard GUI comprises virtual ivory keys that correspond to physical ivory keys of an ivory keyboard interface. The signal chain GUI also comprises a second signal chain routing that includes a second virtual instrument plug-in and a second ivory keyboard GUI. The second ivory keyboard GUI comprises virtual ivory keys that correspond to the physical ivory keys of the ivory keyboard interface. The method comprises the additional steps selecting a first set of contiguous virtual keys on the first ivory keyboard GUI; and associating a first set of physical ivory keys on the ivory keyboard interface with the first virtual instrument plug-in. The first set of physical ivory keys correspond with the first set of contiguous virtual keys.

In embodiments of the invention a song configuration sustain function may also be provided to enable a user to sustain a sound from the end of a first song configuration while a second song configuration is selected from a GUI screen, configured and while the user begins to play the second song configuration. The sounds from the end of the first song may be sustained for as long as the user holds the notes via a MIDI enabled device such as an ivory keyboard interface or other MIDI enabled button interface. The host software of an exemplary music production system is configured to cause processor circuitry to display a user created set of songs in a set list GUI displayed on a GUI display. Each song (or preset) displayed may represent a user defined song or preset configuration comprising track data, rack data, sound plug-in data and effect plug-in data. The data and related plug-ins associated with each displayed song is loaded from a memory storage device into RAM and/or cache memory that is associated with the exemplary music production system. When the user selects a first song (or preset) on the set list GUI, the virtual and/or physical configuration for the first song is configured using the loaded data and plug-ins. The user can then perform the song via the first song configuration. When the user gets to the last performance notes of the first song, he can hold or sustain those notes by continuously pressing the ivory keys of a MIDI ivory keyboard interface. At the same time, the user may select a second song, which is immediately configured as a second song configuration in a similar manner as the first song was configured. The user can now begin playing new notes associated with performing the second song via the second song configuration while the final notes of the first song configuration are sustained. Thus, embodiments of the invention may be configured to maintain a configuration of a first song configuration, while configuring and allowing processing of signal streams associated with a configured second song configuration.

In further embodiments of the invention, a music production system is provided that enables a user to create one or more live objects that are displayed on a GUI screen as virtual MIDI controllers (live controllers). A user may create a variety of types of live controllers and place and/or sized them in user selected positions on the GUI screen. The user may set the MIDI controller command(s) (MIDI CC) to be sent by each of the user created live controllers when the user adjusts the live controller via a touch screen associated with the GUI screen or via an input device. Embodiments provide a MIDI driver that is adapted for and enables receipt of a MIDI CC generated from a live control. The MIDI driver further is adapted for and enables forwarding or sending received MIDI CCs to the host software, plug-in software being utilized by the host software, other MIDI enabled applications or software running on a same or related processor as the host software, or to external MIDI enabled applications or devices via MIDI I/O port associated with an exemplary music production system.

### BRIEF DESCRIPTION OF THE DRAWINGS

For a more complete understanding, reference is now made to the following description taken in conjunction with the accompanying Drawings in which:

FIG. 1 is a block diagram of an exemplary universal music production system.

FIG. 2 shows a display screen of an embodiment of the invention.

FIG. 3 shows a display screen of an embodiment of the invention.

FIG. 4 shows a display screen of an embodiment of the invention.

FIG. 5 shows a display screen of an embodiment of the invention.

FIG. 6 shows a display screen of an embodiment of the invention.

FIG. 7 shows a display screen of an embodiment of the invention.

FIG. 8 shows a display screen of an embodiment of the invention.

FIG. 9 shows a display screen of an embodiment of the invention.

FIG. 10 shows a display screen of an embodiment of the invention.

FIG. 11 shows a display screen of an embodiment of the invention.

FIG. 12 shows a display screen of an embodiment of the invention.

FIG. 13 shows a display screen of an embodiment of the invention.

FIG. 14 shows a display screen of an embodiment of the invention.

FIG. 15 shows a display screen of an embodiment of the invention.

FIG. 16 shows a display screen of an embodiment of the invention.

FIG. 17 is a visual indication of how data is related in an embodiment of the invention.

FIG. 18 shows a display screen of an embodiment of the invention.

FIG. 19 shows a display screen of an embodiment of the invention.

FIG. 20 shows a display screen of an embodiment of the invention.

FIG. 21 shows a display screen of an embodiment of the invention.

FIG. 22 shows a display screen of an embodiment of the invention.

FIG. 23 shows a display screen of an embodiment of the invention.

FIG. 24 shows a flow diagram of a learn function of an embodiment of the invention.

FIG. 25 shows a display screen of an embodiment of the invention.

FIG. 25A shows a display screen of an embodiment of the invention.

FIG. 25B shows a display screen of an embodiment of the invention.

FIG. 26 shows a nested learn function concept of an embodiment of the invention.

FIG. 27 shows a nested learn function method of an embodiment of the invention.

FIG. 28 shows a display screen of an embodiment of the invention.

FIG. 29 shows a display screen of an embodiment of the invention.

FIG. 30 shows a signal flow diagram of an embodiment of the invention.

### DETAILED DESCRIPTION

Referring now to the drawings, wherein like reference numbers are used herein to designate like elements throughout, the various views and embodiments of a universal music production system that provides both detailed and accurate control of audio and Musical Instrument Digital Interface (MIDI) signals required in off-line and studio audio processing and music production, while at the same time also provides realtime, specific functionality in an ergonomic manner that enables and facilitates a user to provide a similar level of detailed and accurate audio control during a live realtime performance are illustrated and described, along with other possible embodiments. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

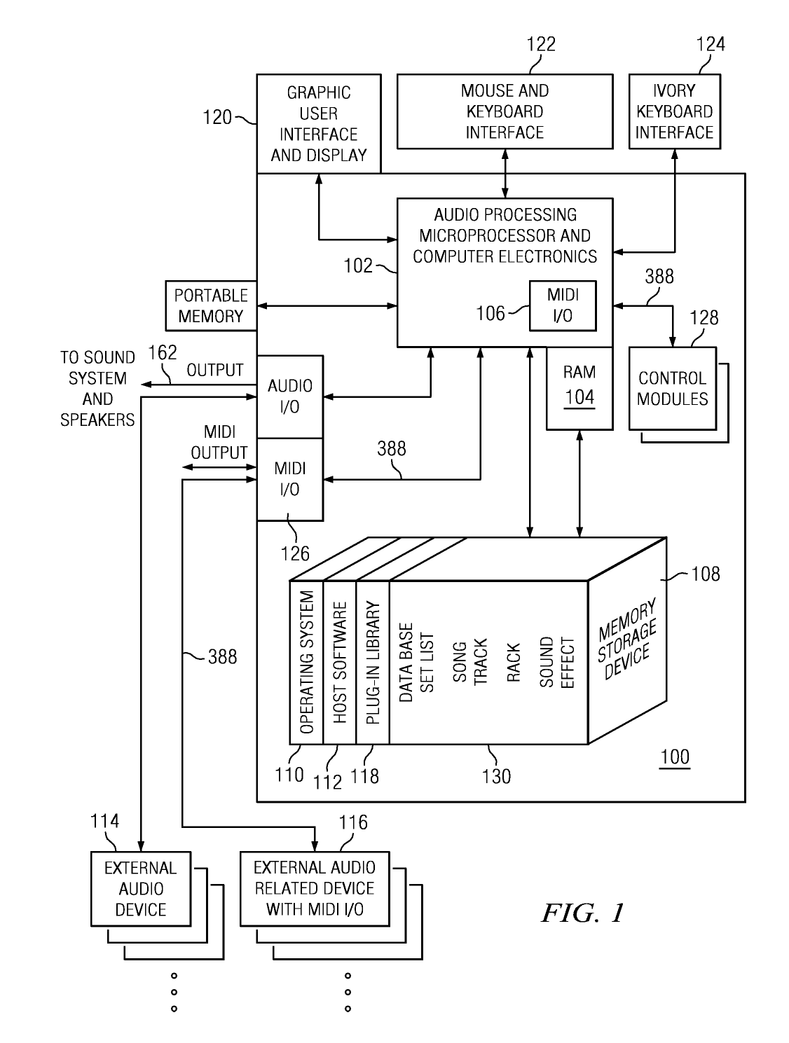

FIG. 1 depicts an exemplary block diagram embodiment of a music production system 100. The exemplary music production system (MPS) 100 provides user control of audio processing, audio control systems, and related audio equipment. An exemplary MPS 100 provides a means for controlling audio synthesizers and processors accurately and smoothly during a live stage performance or in other types of live entertainment environments. Embodiments of the MPS 100 include both hardware and software improvements that allow a user accessibility and fluid control of audio processing and music production related adjustments, which when in a recording studio require painstaking patience and detail. Embodiments provide enhanced functionality and ergonomics that facilitate and enhance control of physical devices and virtual studio technology (VST) devices, API audio-related modules and MIDI controlled and producing devices during a live performance.

An exemplary MPS 100 comprises an audio processing microprocessor or general purpose microprocessor with related computer/motherboard electronics 102. The microprocessor 102 may be a single, dual, triple, quad or larger core microprocessor installed on a motherboard. A large amount of random access memory (RAM) 104 is associated with the audio processing microprocessor and computer electronics 102. The amount of RAM associated may be in the 1-16 gigabyte range or larger to help enable the 32, 64 or 128 bit audio processing microprocessor 102 to cache and handle the data manipulation and throughput associated the embodiments of the invention 100. A motherboard MIDI I/O module 106 or related circuit may also be included with the audio processing microprocessor circuitry 102. This is done since MIDI is an accepted industry-standard protocol that enables electronic musical instruments and related devices such as keyboard controllers, computers and other electronic equipment to communicate, control and synchronize with each other.

A memory storage device (or devices) 108, such as a hard drive, optical drive, flash drive or any reasonable facsimile or derivation thereof, stores the operating system 110 used by the audio processing microprocessor 102. Such operating systems may be a Microsoft Windows® operating system, Linux® OS, Mac® OS, or another operating system that meets the requirements of an exemplary embodiment 100.

Host software 112 is stored on the memory storage device 108. The host software 112 is read and utilized by the audio processing microprocessor and computer electronics 102 from the memory storage device. The host software 112 comprises a plurality of instructions wherein at the least a portion of the plurality of instructions are configured to cause the audio processing microprocessor to perform various functions in accordance with the embodiments of the universal music production system 100. In one embodiment, the host software 112 provides a virtual multi-effect and multi-instrument rack for musicians and sound engineers. The multi-effect and multi-instrument rack allows a user to combine, in a virtual environment, fully configurable connections of both physical devices and virtual studio technology (VST) device plug-ins into an extremely versatile instrument. A physical device may be one or more external audio devices 114 such an electric guitar, a electric keyboard, an electric violin, an electric drum set, a microphone, an audio playback device such as a CD player, reel-to-reel tape player, record player, radio, stereo system, digital recording device output or any other audio device with an audio output. Furthermore, a physical device may be an external audio-related device having a MIDI I/O 116. Examples of external audio-related devices with MIDI I/Os could be substantially any type of device with an associated MIDI controller including devices with sliders, rotary encoders, push buttons, touch-sensitive strips, two or three dimensional touch-sensitive devices, foot pedals, lighting equipment and various musical equipment such as organs, metronomes, synthesizer outputs and various other equipment of a virtually unlimited variety that provide MIDI output and/or that may accept MIDI input signals. Vast varieties of devices can be organized, controlled and configured to a user's predetermined set of settings necessary for a song performance or live performance with a single touch of an exemplary embodiment's button. Embodiments of the invention further facilitate streaming of VST input signals through user configured channels of individual VST (“plug-in”) effects to provide “substantially real-time” multi-effect processing of an audio signal. The “substantial real-time” multi-effect processing is delayed or latent due to the nature of the Windows operating system, but is not due to loading of additional plug-ins or database data from a data base because such loading and database data is stored in RAM memory or Cache memory when the set is loaded. Substantially real-time means processing multi-effect audio signals without humanly perceived delay. Additional embodiments 100 enable a user to play several VST instruments simultaneously with hundreds, if not thousands, of predetermined plug-in parameters and settings that are set via a single press of a button or input of an instruction by the user. With a second button press, all such signal chains can be reconfigured to a second set of hundreds, or thousands, of preconfigured plug-in parameters and settings without generating undo or annoying output sounds during the transition. In addition, embodiments of the invention can layer or combine several instruments in a plethora of different ways thereby to create complex and never before heard organized and rhythmic sounds.

### Terminology

### Audio Effect

A type of plug-in that accepts an audio stream, processes or alters the audio stream in a predefined manner and outputs that processed audio stream. Examples of the processing functions provided include but are not limited to compression, distortion and reverberation.

### Audio Effect Chain

A collection of plug-ins that starts with an audio input stream and may go through a chain of audio effects plug-ins before providing an output to an audio bus.

### Bank

A collection of Presets and Preset Groups that are loaded into memory for easy access by the user.

### Component

A collection of controls. A way to group controls that work together to provide service to the user.

### Control/Controller

A single graphical user interface (GUI) item on a GUI screen that performs a task. Examples include but are not limited to; list boxes, right click menus and OK buttons.

### Instrument or Sound Generator

A type of plug-n that accepts Midi data and outputs an audio stream. Examples of an instrument or sound generator are virtual synthesizers and virtual drum modules or plug-ins.

### Link

A Link is the connection between a plug-in parameter and a physical hardware control or a virtual soft control. Physical hardware controls may be connected via a MIDI signal. An example of a link would be when a user moves a hardware MIDI knob and the volume output of a soft synth changes.

### Link Map

A collection of links, grouped by the associated plug-in.

### MIDI Effect

A type of plug-in that accepts a MIDI stream, processes or alters the MIDI stream in a predefined manner and outputs that processed MIDI stream. Examples of the processing functions provided include but are not limited to arpeggiators, chorders and MIDI echo.

### Plug-In

Within the context of this disclosure, plug-ins are audio processing modules usually, although not limited to, in the VST or DX format. Plug-ins are third party Dynamic Link Libraries (DLLs) that take an input stream and produce an output stream or streams. A stream may be a MIDI signal or digital audio.

### Plug-In Parameter

A plug-in may provide control of its functionality through parameters. These parameters may be exposed through a virtual or physical control panel of the invention.

### Preset or Song Configuration

A preset or song is a collection of instrument plug-ins and audio effect plug-in chains that may have unique parameter settings for each plug-in in the preset or song configuration. A preset may be something that a user would like to add to or incorporate into a song.

### Preset Group

A user defined group of Presets contained within a Bank. A preset group may be characteristically similar to a set list.

### Shared Plug-In

A single plug-in may be reused within a song or set list. Plug-ins that share the same instance are called Shared Plug-ins.

### Signal Chain

A collection of plug-ins that starts with an audio input stream and ends with an audio output stream. In between there may be one or more audio effect plug-ins. Signal chains may be used when running audio signals such as vocal or, guitar feeds into the exemplary host invention for live processing.

### Stream Processor

A collection of plug-ins (including one VST instrument or in the case of and audio input, an audio effect) that starts with a MIDI input which may then be processed through MIDI effect plug-ins. The MIDI signal may then provide control for an instrument plug-in. The output of the instrument plug-in may further be routed through audio effect plug-ins before the output to an audio bus. A stream processor may be created if a user wants to play an instrument by loading, for example, a VST instrument.

### Set List

A high level construct that may contain a sets of data that represent a combination of background audio tracks, sequencer tracks, presets, songs, parameters for an input audio effects chain or parameters for the output audio effects/signal chain. A set list may include all the different songs (song configurations) that are to be performed at a performance.

### Widget

GUI elements that a user may define and add to create a custom control interface to give access to plug-in parameters. An example of a widget may include but not be limited to the Live Control elements of an embodiment of the invention.

Because of the highly configurable nature of the invention embodiments, much of the control interface may be provided through a graphic user interface touch and display screen 120 such that embodiments of the invention, as illustrated in the Figures, may be advantageously controlled. The touch screen or touch screen display 120 may be either an integral part of the invention 100 or may be a separate device electrically connected and or in communication with embodiments of the invention. However, embodiments are not so constrained and such control may be affected through a mouse, trackball, trackpad, joystick, cursor control or other device 122. Further, it is well known when using a mouse or other computer input device to use a ‘right click’ menu as a means of quickly accessing the parameters of a control, window or other on-screen construct. The term ‘right click’ eponymously refers to the switch on a mouse or trackball positioned on the right side of said device; however, the term has attained a more generic meaning as any method for signifying an alternate or modified selection of a control, window or other on-screen construct. In particular, in an embodiment of the disclosed invention the ‘right click’ functionality is provided through the user selecting an object on screen 120 using the touchscreen and then subsequently touching an area of the screen 120 on the touch screen. Pressing the ‘right click’ button forces the MPS to interpret the next user generated left click as a right click. This allows users to access right click menus and functionality without an actual right mouse button click. The system sees this combination of events as equivalent to a ‘right click’ event and will offer the selection menu or other response appropriate to the ‘right click’ function. Thus, an alternate click functionality is provided for a physical device or a single touch touchscreen, which inherently possesses only primary click (commonly known as left click) hardware. However, the invention is not so limited. In further embodiments of the invention, multi-touch touch screens and input devices may be used where alternate forms of input, including right-click, may be utilized without detracting from the spirit of the invention.

Still referring to FIG. 1, an exemplary MPS 100 may store the plurality of plug-ins in the plug-in library 118. Each plug-in may have a plurality plug-in parameters that can be set by the user via the graphic user interface 120. The graphic user interface 120 may be a touch screen monitor, flat screen LCD or LED display or other touch sensitive graphic display device. The graphic user interface 120 may be incorporated into and as a removable part of an exemplary MPS 100. In other embodiments, the graphic user interface 120 may be a separate, external, stand-alone touch sensitive display device electrically connected to the MPS 100 and its associated audio processing and computer electronics 102 therein. A keyboard and pointer device 122 may be plugged in to or removably connected to embodiments of the MPS 100. The pointer device may be a mouse, trackball, light pen or optical-based device, wireless pointer device or any other type of pointing device known in the art.

An ivory keyboard interface, like the graphic user interface 120, may also be part of or separate from an exemplary MPS 100. The ivory keyboard interface 124 will allow the user to not only provide the input means similar to any advanced electronic keyboard but may also be used to control external devices 116 such as video players, lighting systems and other MIDI controlled devices connected to the MIDI I/O circuitry 126.

In addition to the graphic user interface 120, the pointing device and/or keyboard interface 122 and the ivory keyboard 124, embodiments of the MPS 100 have at least one control module or MIDI control module 128 that comprises additional means for a user to adjust various parameters associated with the different signal chains, instruments, audio effects, presets, plug-ins and MIDI effects controlled by an exemplary MPS 100. MIDI controller modules 128 may come in a variety of designs and configurations. Such MIDI control modules 128 may be mounted on the upper or side surface of an MPS 100 to enable easy access to such controllers by a user. One exemplary MIDI control module 128 may comprise a plurality of MIDI sliders, MIDI buttons, MIDI rotary encoders, and perhaps an LED or LCD strip to provide blinking feedback, written words or graphics to remind the user what each MIDI device is or what the MIDI control module has been programmed to link with. Another exemplary MIDI controller 128 may be a master panel MIDI control module comprising transport buttons for a multi-track recorder (i.e., fast-forward, fast-reverse, step forward, stop, play, skip, and pause controllers), a user definable LCD strip allowing a user to enter names or descriptions for the various buttons or knobs on the master control panel may also be provided so that the user does not have to memorize the function or device that the particular knob or button controls. Buttons can be programmed to sense beats per minute (BPM), to turn on and off external devices or audio related devices, or to interact with substantially any MIDI device connected to, wired, wirelessly interacting with an exemplary MPS 100. Yet other embodiments of the MIDI control modules 128, each being removably attached to the upper or side surface of the exemplary MPS 100, may be a drum module providing a plurality of drum pads and other drum related MIDI rotary encoder knobs, switches and buttons. A repeat pad may be provided on an exemplary MIDI drum pad module. A repeat pad will make the same sound, when tapped, as the just-previously tapped drum pad. This enables the user to create ⅛ and 1/16 note drum rolls of the same note without having to hit the same pad with fingers from both hands.

As a user utilizes the host software 112 with the various user interfaces 120, 122, 124 and 128 and the various plug-ins from the plug-in library 118, the host software 112 creates a database 130 comprising the user defined and stored set lists wherein each set list may comprise one or more song configurations or presets. Each song configuration (“preset”) may comprise one or more tracks of instruments or sounds that are configured with a song. Each track or instrument that is configured may comprise a rack of various VST devices that produce sounds and which are modified by various effects. All this data information is stored in the database 130 such that a user can store a plurality of organized set lists wherein each set list comprises one or more preprogrammed presets of preset electronic, physical and virtual instrument settings for one or more components or audio devices associated with a particular song. The database 130 will be discussed in somewhat more detail hereinbelow.

The graphic user interface 120, via the microprocessor electronics 102, the operating system 110 and the host software 112 will provide various visual screens or graphic user interfaces (GUIs) on the graphic user interface and touchscreen monitor 120. The exemplary screens and visible controls provided herein are illustrated only as embodiments of the invention and are not constrained to the specific layouts or graphics depicted therein. One of the features of the embodiments of the MPS 100 is its flexibility with the graphic user interface screen design and layout such that the user is being given significant control over the appearance and structure of the control screens and user interfaces therein. This flexibility is a key feature of some of the embodiments of the invention and is particularly important to live performance functions where a user desires to position a user created control, switch, fader, and so on, graphically on the touch-sensitive graphic user interface 120 in a manner that is ergonomic to the user during a performance. The embodiments' flexibility allows for fluid, expressive and enhanced artistic control of the user's planned performance.

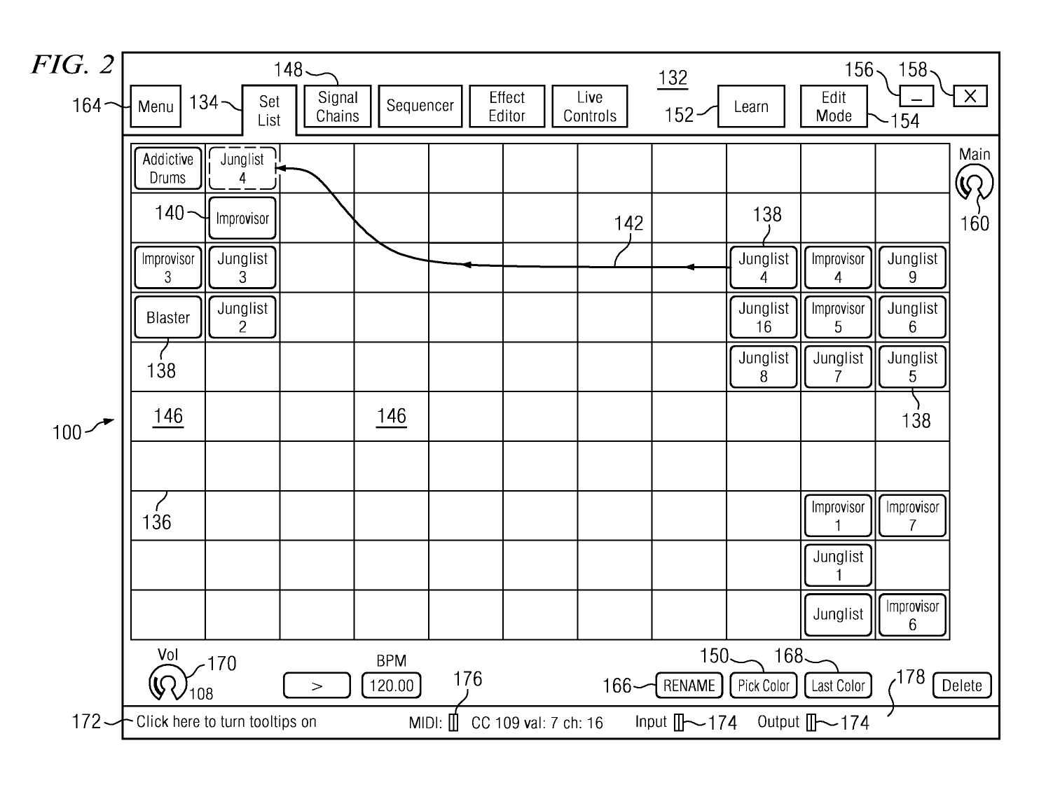

FIG. 2 depicts an embodiment of a graphic user interface layout for a user configured set list GUI 132. Before going into detail of the set list GUI 132, this embodiment of a GUI display screen provides multiple tabs (“navigation tabs”) across the top of the screen (here labeled “Set List”, “Signal Chains”, “Sequencers”, “Effect Editor”, and “Live Controls”) that allow for quick access to multiple different and independent control screens, all of which are produced by the underlying host software 112. In FIG. 2, the “Set List” tab 134 is active as indicated by the gap in the line beneath the words “Set List”. The line is solid beneath the other tab names, “Signal Chains”, “Sequencers”, “Effect Editor”, and “Live Controls” showing they are currently unselected. The navigation tabs may be used to navigate between the different windows and associated software provided by the host software 112. A right click (via the pointing device or mouse 122) on any tab brings up a Learn option. When the Learn option is on, the tabs can be Linked to a MIDI controller as will be described herein later.

The set list GUI 132, with the Set List tab 134 being the active tab, is the first screen a user of the host software 112 views on the graphic user interface 120 when the host system is loaded and operating via the operating system 110 and audio processing microprocessor and computer electronics 102. Below the set list tab 134, in this exemplary embodiment, is a set list grid 136. A plurality of Chiclet-shaped buttons 138 are graphically displayed in various compartments of the set list grid 136. Each button 138 represents a preset group of preset sounds and parameters. The user can select a preset group of sounds and parameters by touching or clicking the particular button 138 inside the set list grid 136 on the touchscreen of the graphic user interface 120. This set list GUI screen 132 provides high level functionality that allows a user to set up and reorganize an entire set of song performance configurations and/or sounds through the arrangement of the buttons 138 alone. For example, the Improviser preset button 140 may represent a configuration and associated parameters for a plurality of instruments, effects, sounds, racks and tracks for a particular song “Improviser” that are to be configured during a live performance of the “Improviser” song.

The various buttons 138 can be ordered and moved about the set list grid 136 by a user by touching the particular button on the touchscreen or clicking on the button via a mouse or other pointing device and moving the button as shown via arrow 142. Using this technique, a user can organize a set of various set of song buttons in a manner that would make sense to the user during a live performance. When a preset button 138 is selected, via the GUI touchscreen or a mouse or other pointing device, the selected preset button 138 may pulsate and/or display slightly larger than the other non-selected preset buttons 138.

When a user clicks or touches an unassigned grid area 146 or right clicks on the unassigned grid area 146, the host software 112 may display a subsidiary menu containing a variety of user options (not specifically shown). One of the user options is an add option. The add option, when selected, brings up the Sound Browser (as described below). Another option is the Add Favorite option, which when selected, brings up a submenu of Categories from the Sound Browser. The user can select a plug-in directly from the submenu and the Categories can be user defined. Categories comprise the various different categories of sounds or effects provided by a plug-in or plug-in instruments. For example, a category may be percussion, woodwind or bass to name a few. Another option from the drop-down menu is the paste option. If the paste option is selected and if a preset item is on a clipboard from a previous performed copy function, then the preset will be copied into the selected unassigned grid area 136 as a new button 138.

When a user clicks or touches an assigned preset button 138 or by otherwise generating a “right click” event, the host software 112 may display a subsidiary menu on the graphic user interface 120 that contains the following possible entries:
a. Show Signal Chain—Selecting show signal chain of this exemplary subsidiary menu performs the same function as if the user had selected the Signal Chains tab 148. The Signal Chains tab 148 takes a user to the signal chain GUI screen for the selected preset.
b. Rename—Selecting rename directs the host software 112 to allow the user to rename the selected preset button 138.
c. Color—Selecting color on this menu performs the same function as the pick color button 150 provided at the bottom of the exemplary set list GUI 132. Selecting the color or pick color option 150 instructs the host software 112 to allow the user to select the color for the selected preset button 138.
d. Cut—Selection of the cut removes the preset button 138 from the set list grid 136 and places it on the clipboard to be available for the paste option.
e. Copy—Selecting the copy option copies the preset button 138 and its contents to the clipboard in preparation for a paste event.
f. Delete—Selection of the delete option removes the selected preset button 138 from this set list grid 136 bank, but does not delete the item from the entire system.

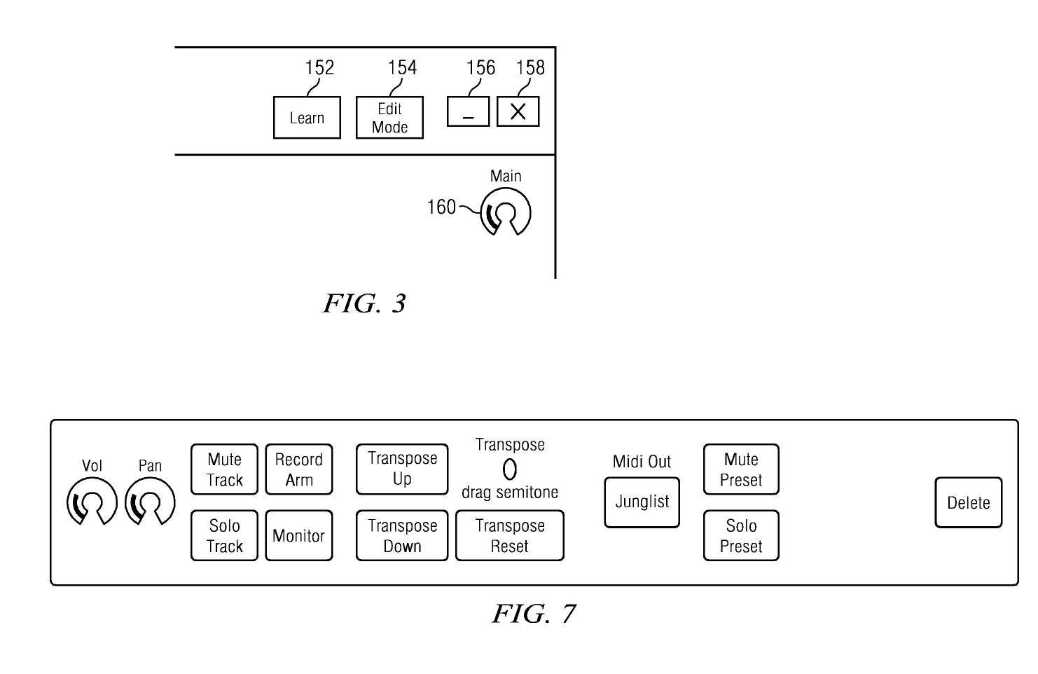

FIG. 3 shows an embodiment of the main title bar controls for the set list GUI 132 screen in more detail. The learn button 152, when touched by a user or clicked on with a pointer device, switches the host software 112 into MIDI learn mode. When the host software is switched into MIDI learn mode, the next MIDI signal received by the MIDI I/O 126 or MIDI I/O 106 (see FIG. 1) will link or latch to a control element or physical control element that was selected immediately prior to touching or clicking on the learn button 101. The host software 112 provides a variety of types of learn functionality that includes, but are not limited to: 1) tying an input control to a specific controller; 2) a learn relevant function that ties an input MIDI control knob, slider, button on a control module 128 to a controller in a VST plug-in and the link stays latched to control the function, for example, volume, of whichever preset button 138 is selected. In other words, whichever preset is in focus and selected by the user will have its function, such as volume, controlled by the latched control knob slider or button; 3) a learn operation may also tie one input control to another input control or a combination of input controls, which may in turn be tied to a specific controller (“nesting”).

Another button or control on the set list GUI screen 132 is the edit mode control 154 that toggles between edit mode and live mode. When a user selects edit mode and thereby places the host software 112 in edit mode, the host software allows the user to move around the various presets 138, arrange them in any order as shown by the arrow 142, set all of the properties or some of the properties of the Banks and create additional or delete tabs. In edit mode, a user essentially may go through the detailed tasks of setting up hardware and VST plug-in devices, creating sound chains and other necessary steps or wanted for configuring a particular preset, groups of presets, set lists or Banks Conversely, when the user deselects edit mode and the host software 112 is operating in live mode, many of the features and user programmable functions associated with the host software's GUI interfaces are locked so that they are not accidently changed during a live performance. When the edit mode control 102 is toggled to live mode, embodiments of the invention may restrict a user from utilizing functions that were available in Edit mode in the following manner.
1. The user may not edit any of the live control parameters. The user may use the live controls as configured in a selected preset 138, but editing what the control is linked to or how it operates is locked out in live mode.
2. The host software program 112 cannot be exited in live mode.
3. In live mode, no “right click” menus are provided with a one potential exception. The one exception being to use the right click to toggle between live mode and edit mode.
4. During live mode, Banks cannot be added to or removed.
5. During live mode, instruments cannot be added or removed from signal chains within any preset.
6. During live mode, effects cannot be added or removed from within a signal chain or present.
7. During live mode, new files cannot be opened.

Still referring to FIG. 2 the “−” button 156 minimizes the host software GUI screen while the “X” button 158 is a symbol for closing or exiting the host software 112. A main volume knob GUI 160 is provided on each graphic user interface screen as the main output volume that controls the overall master output 162 of an exemplary system 100. The main volume knob 162 can be manipulated by a user by touching the master volume GUI 160 on the graphic user interface screen 120 or with a pointer device 122 and dragging the volume band left/right or up/down to change its value.

When a user selects the main menu button 164, shown in FIG. 2, the host software 112 presents the user with the following options:

a. File
i. New Set
   1. Creates a new blank Set grid 136/146 or launches a selected set list.
   2. Launches a confirmation dialog, because creating a new set may delete of the current one if not saved.
   3. If the user does want to make a new Set and the current Set hasn't been saved then it will then ask the user if they want to save the current Bank of the currently displayed set list.

b. Open Set
i. Opens the Set List Dialog.

c. Open Recent
i. Lists recently accessed set lists. Selecting a Set from here will launch and perform the same confirmation as the New Set dialog

d. Save Set
i. Saves the current Set to permanent storage. If no changes have been made to a Set then this is grayed out.

e. Exit
i. Launches a confirmation dialog that asks if the user really wants to Quit the Host and go to the Windows Desktop.

f. Edit
i. Undo
   1. Roll back one item on the undo stack.
   2. Is grayed out if there is nothing to undo.
ii. Redo
   1. Move forward one item on the undo stack.
   2. Is grayed out if it cannot move forward.

g. Options
i. Options
   1. Launches the options dialog.
   2. All the audio, midi and general options in one dialog.
ii. Stress Test
   1. Launches stress test dialog. This will start a stress test on presets, instruments and plug-ins. The stress test determines if the preselected plug-ins, parameters, tracks, and other settings in a preset can operate correctly without delay or lock-up in live mode.
iii. Set Look and Feel
   1. Launches the Look and Feel dialog.
iv. Password Mode
   1. Puts machine in a locked out password mode.
   2. Modal password dialog.
   3. No MIDI or screen input accepted.

h. Help
i. Open Help
   1. Opens a help file.

ii. About—Launches About dialog.

Still referring to FIG. 2, the rename button/control 166 allows the user, via the host software 112, to rename a selected preset button 138. The pick color button control 150, as described above, when selected, will bring up a color picker dialog box by the host software wherein the user can select a color choice for a selected preset button control 138. The last color button control 168 will assign a selected preset button control 138 the same color as the last selected color or the same color as the last selected preset button 138. This last color button control 168 allows a user to easily set a plurality or group of presets 138 to all have the same user selected color.

The volume control 170 provides a volume knob that can control the volume on an individually selected preset 138. This volume GUI knob 170 is independent from the main volume control 160, but may operate in conjunction therewith. Via the host software, the user may right click on the volume control GUI 170 and bring up learn mode. Once in learn mode, the user can tie the volume control GUI 170 to a specific controller or set it to learn relative such that the volume control GUI 170 is latched to control the volume of whatever preset 138 is selected or in focus. That is this volume knob may only control the volume of the particular preset selected but not the main output volume of the exemplary music production system 100.

Clicking on the “Click Here to Turn Tool Tips On” 172 portion at the bottom left hand corner of the set list GUI 132, the host software will display tool tip information on what the user has selected in the GUI and will show a numerical value of the changed parameter and/or the name brief description of a control as it is moused-over with a pointer device 122. The audio input and output VU meters 174 provide a visual display for the user indicating when input signal(s) and output signal(s) are present or being provided. The MIDI indicator 176 provides an indication to the user that the host software is in receipt of an MIDI signal from any controller. Next to the MIDI indicator 176 the host system and software may display the note/MIDI value of a receipt of a received MIDI signal.

Not specifically shown in the status bar 178, GUI messages, indicators, or controls that could be provided in the status bar may further include, but are not limited to, the current CPU usage, which could use color indicators, a meter, bar graphs or otherwise to indicate when the microprocessor or CPU is operating close to its maximum. If the microprocessor of the audio micro-processing microprocessor 102 is a multi-core or multi-processor device or system, then the number of processors/cores may be displayed in parenthesis next to the usage meter or indicator. Furthermore, the status bar 178 may include a memory meter showing the amount of physical memory usage or RAM memory usage being utilized by the host software 112 in the entire operating system 110 so that a user has an indication of when physical or RAM memory gets low.

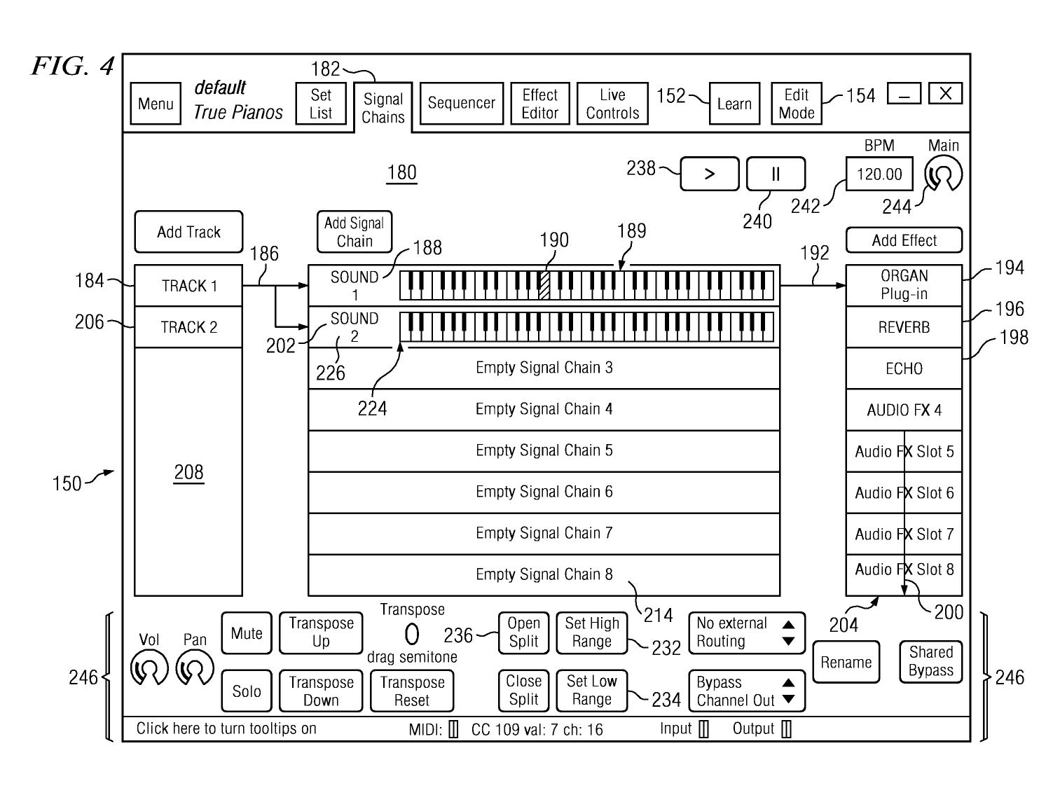

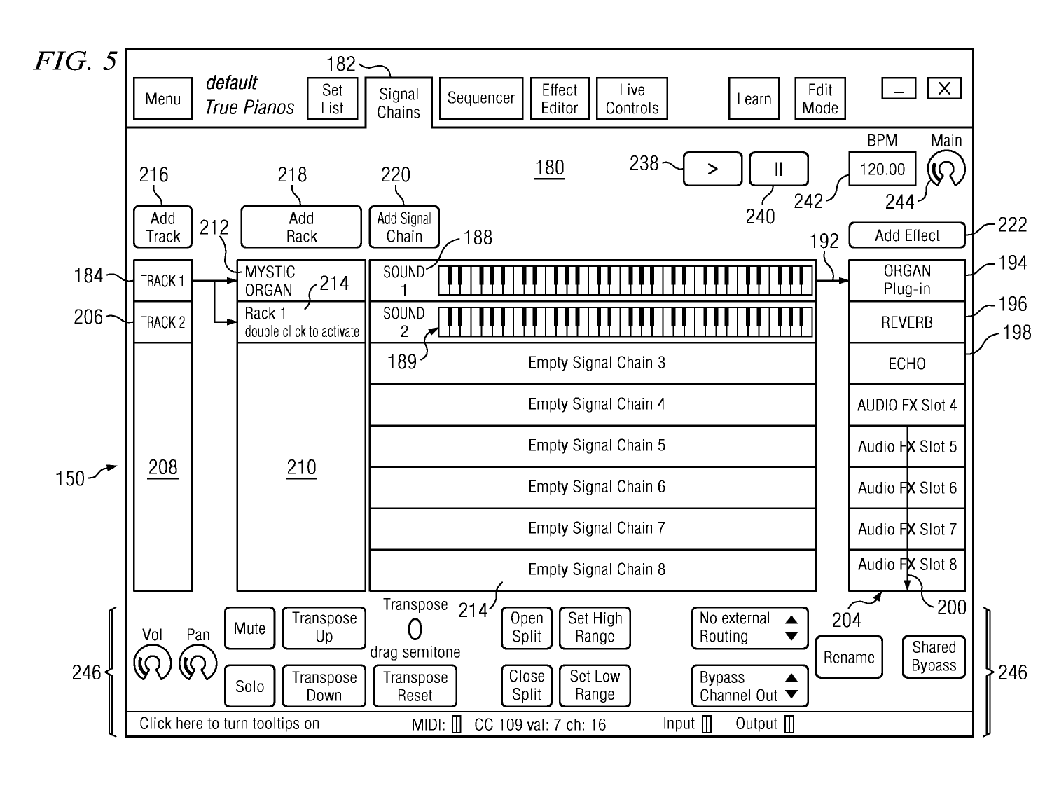

FIGS. 4 and 5 show embodiments of the signal chain GUI 180, which may be displayed on the graphic user interface 120 via the host software 112. Here the signal chains tab 182 has been selected by the user. As depicted in FIGS. 4 and 5, a signal chain is a collection of plug-ins that start with an audio input stream and end with an audio output stream. In between the audio input stream and audio output stream, there may be one or more audio effect plug-in(s) that effect the signal/data passing therethrough via a user selected set of plug-in parameters. Signal chains are where track, rack, sound and effect chains are created and managed. An arrangement of instrument track, rack, sound and effect chains along with parameters associated therewith are created on this screen by a user and stored in RAM 104 and/or the database 130 of FIG. 1.

When in edit mode, a user may touch or select a preset 138 in the set list GUI 132 in order to define and edit various signal chains associated with that selected preset button 138. Each of the preset buttons on the set list GUI 132 may be associated with at least one signal chain or track on the signal chain GUI screen 180.

Referring to FIG. 4, the user via the host software 112 interacts with the signal chain GUI 180 by, for example, setting a first track 184 for configuration. The signal chain then continues in the direction of the signal chain arrows 186 into, in this exemplary embodiment, two simultaneously played VST instruments. The first instrument signal chain for track one is shown as a keyboard labeled as sound 1 188. The keyboard 189 is a representation of an ivory keyboard 124 (see FIG. 1) that is connected via a MIDI connection or is part of an exemplary music production system 100. As a user presses the keys of the ivory keyboard 124, those keys/notes are shown as darkened keys 190 on the keyboard representation of the sound 1 chain 189. The signal chain arrows 192 indicate that the note being played by a user 190 is then provided, in this example of a signal chain, into an audio-effects slot 194 called an organ. The organ is a VST plug-in instrument selected and placed in the audio effects slot 194 such that the key/note 190 is effected by the organ plug-in device to make an organ sound for the selected key 190. A user may add another audio effect plug-in in the signal chain after the organ 194. In this example, a reverb effects plug-in 196 is placed in the signal chain after the organ 194. The user then can insert additional effects plug-ins, such as an echo effect plug-in 198, in the signal chain to add additional modification to the sound 190. In this embodiment, up to eight effects can be added to the signal chain in the stream processor column 204. The signal chain output 200 represents the signal out sound that is provided at the end of the signal chain for track 1 sound 1.

Track 1 184 sound 2 202 can be a second instrument, such as a piano, that is part of the track 1 signal chain and is played simultaneously with the track 1 sound 1. The track 1 sound 2 signal chain, when being viewed by a user via the host software 112, will have an arrow similar to signal chain arrow 192 entering into the effect and plug-in stream processor column 204 into a different order of plug-in sounds and effects perhaps titled grand piano (instead of organ) and then have a delay effect or user selected other effect plug-ins there below in the stream processor column 204.

In an embodiment of the invention as shown in FIG. 4, each track 184 or signal chain may be composed of up to eight instruments (i.e., sound 1 188, sound 2 202) and each instrument may have one instrument sound or plug-in, such as the organ plug-in 194, and seven effect plug-ins, such as the reverb 196 and echo 198, added to it. However, various embodiment of the invention are not so limited and other numbers of instruments, plug-ins, and effects may be used without departing from the essentials of the invention. This sound flow on the signal chain GUI 180 is generally from the left side of the display screen 120 toward the right as shown by the signal chain arrows 186 and 192 toward the signal chain output 200.

Thus, it should be understood that each preset 138 on the set list GUI 132 may contain a plurality of tracks such as track 1 184 and track 2 206. Each track may contain, for example, eight instruments such as an organ, a piano, a guitar sound, violin, synthesizer, etc. Each instrument may be provided as a plug-in, such as an organ plug-in 194, or may be an audio input from an external audio device such as from an electric guitar or microphone, or an external audio-related MIDI device 116 such as an electric organ or other electronic instrument or synthesizer. Each signal chain can then be provided to a synth or instrument plug-in, again such as the organ plug-in 194 plus an additional seven effect plug-ins such as the reverb plug-in 196 or echo plug-in 198. The host software 112, via the database 113 and the plug-in library 118, processes each signal chain thereby to produce the appropriate signal chain output 200 and, in turn and simultaneously, the overall master output 162.

Referring to FIG. 5, a racks column 210 is shown as included in the track 1 signal chain. The racks column 210 may be toggled on and off by the user as necessary or needed. FIG. 4 shows the signal chain GUI 180 without the racks column displayed while FIG. 5 shows the racks column 210 in use. Each rack may be thought of as the name and set up for each sound in a signal chain of a track. For example, for the sound 1 signal chain of track 1, the rack may be called a mystic organ. The rack represents a snap-shot picture of all of the settings for the currently selected signal chain within a track, which in the mystic organ rack 212 would include the plug-in 194 and all its user selected parameters and settings, the reverb 196 with all its user selected settings parameters and effect parameters, and the echo effect plug-in with all of its user selected settings parameters and effect parameters. Each rack, when defined like the mystic organ rack 212, can be stored in the database 130 and recalled by the user for incorporation into a track of another preset when subsequently desired by the user.

In an attempt to describe the host software 112 interaction with a user via the signal chain GUI 180, the columns rack (track column 208, the rack column 210, the signal chain column 214 and the signal stream processor column 204) each represent the stages of creating a track are now discussed. With respect to the track column 208, selecting the add track button 216 instructs the host software 112 to launch a new track dialog on the GUI 120. In the new track dialog, the user is provided controls for selecting the type of track, MIDI or audio, that the user wants to add. After selecting the type of track to add, the user then may select a name to be loaded into the instrument track 208. If a user double clicks on a block in the add track column 208, such as the track 2 block 206, the corresponding sequencer track will be displayed on the GUI display 120.

Selecting or clicking on the add rack button 218 in the rack column 210 launches a new rack dialog where a user can select and add another rack/signal chain column 214 to the particular track that is in focus.

The signal chain column 214 provides a visual display of the individual signal chains representing each instrument in the track. Selecting the add signal chain button 220 instructs the host software to display a sound browser on the GUI display 120 so that the user can select a plug-in and add it to the instrument rack, which is generally the first position (i.e., 194) at the top of the stream processor column 204. In FIGS. 4 and 5, an organ plug-in 194 is the selected instrument for the sound 1 188 signal chain. In one embodiment of the invention, up to eight instruments or signal chains may be added to each track, for example track 1 184.

The signal stream processor column 204 generally has an instrument plug-in, MIDI VST plug-in, or is utilizing the sound received from an external audio device 114 or external audio device with the MIDI I/O 116 that may be plugged in and physically connected to an embodiment of the MPS 100. Touching or selecting the add effect button 222 instructs the host software 112 to display a sound browser display on the GUI interface display 120. The sound browser display reads effect plug-ins from the plug-in library 118 and lists such effect plug-ins for user selection. The user may select an effect plug-in and add it to the signal chain of the sound or instrument signal chain that is in focus. The name of the selected effect plug-in is added to the stream processor column 204 in a position that is in focus or selected by the user. Audio signals are processed from the top of the signal stream processor column 204 to the bottom. The order of the effect plug-ins such as reverb 196 plug-in and echo plug-in 198, can be switched around to change the signal chain routing and ultimately to output signal sound. Typically the first or top position in the stream processor column 204 is used for placement of a sound generating or instrument plug-in, such as an organ, piano, drums, or any other sound generating or instrument plug-in synthesizer, while the plug-ins that are below the first or top sound plug-in position are effect plug-ins which effect the signal sound. The host software 112 allows a user to add or load MIDI VSTs, which are plug-ins that output MIDI rather than audio signals. MIDI VSTs are placed above any sound generating plug-in such as the organ plug-in 194, so that the MIDI VST can pass the MIDI onto the sound generating plug-in occurring in the sound chain immediately after it.

It is important to understand that there are illogical configurations of MIDI VST plug-ins, sound plug-ins and effect plug-ins that are incapable of passing the signal chain signal without an error in the software of either third party plug-in software or the host software 112. For example, an illogical configuration of the plug-ins in the signal stream processor column 204 might be placing a sound generating plug-in, followed by a MIDI VST, followed by an effect, and then followed by another sound generator. An easy way of understanding how this plug-in order would not work is to imagine that the plug-in devices were actually real, physical devices, rather than virtual sound or effect devices. As such, it would be illogical to hook them up in the sequence described. An improvement of embodiments of the invention is that the host software checks for and will not allow illogical configurations of MIDI VSTs, sound plug-ins and effect plug-ins in the stream processor column 204. The host software logic checking of the signal chain organization in the stream processor column 204 ensures that a user builds an effects-chain that will operate and provide a usable output 200. If an illogical effect configuration or order is attempted in the stream processor column 204, the host software may disallow a drag and drop placement of the effect or plug-in in an illogical order on the GUI, may provide a message to the user via the GUI display 120 or provide an audible sound indicating the an illogical order is not allowable. Thus, attempting an illogical instrument or effect order may result in a form of visible feedback to the user indicating the requested order is not possible. Such visible feedback may include simply disallowing a non-functional sound plug-in, effect plug-in and MIDI VST plug-in combination. The user is ultimately informed, via the GUI screen, when the order of a first plug-in and a second-plug-in will not be operational in an exemplary music production system

Each instrument/sound signal chain column 214 (for each track of a preset or song) may include a representation of an instrument keyboard 189 as shown in both FIGS. 4 and 5. The instrument keyboard 189 dramatically represents the familiar black and white notes of a piano or synthesizer keyboard. However, it can be used to represent the tonal range of any connected instrument, even if it is an actual instrument, such a guitar, which does not utilize such a keyboard. Such keyboards are often referred to an “ivory” keyboard to distinguish them from an alpha-numeric computer keyboard.

In some embodiments, it was found to be advantageous for the host software 112 to enable a user to assign different sets of keys or tonal ranges of such an ivory keyboard to different instruments, effects channels or chains. For example, a user may assign the bottom two octaves of the ivory keyboard 189 to a bass guitar synthesizer, while the remainder of the ivory keyboard in the signal chain is assigned to and controls a piano synthesizer. This assignment of different parts of the ivory keyboard to different instruments or combinations of instruments is often called a keyboard split. In various embodiments of the invention, the host software allows a user to assign such keyboard splits rapidly and easily.

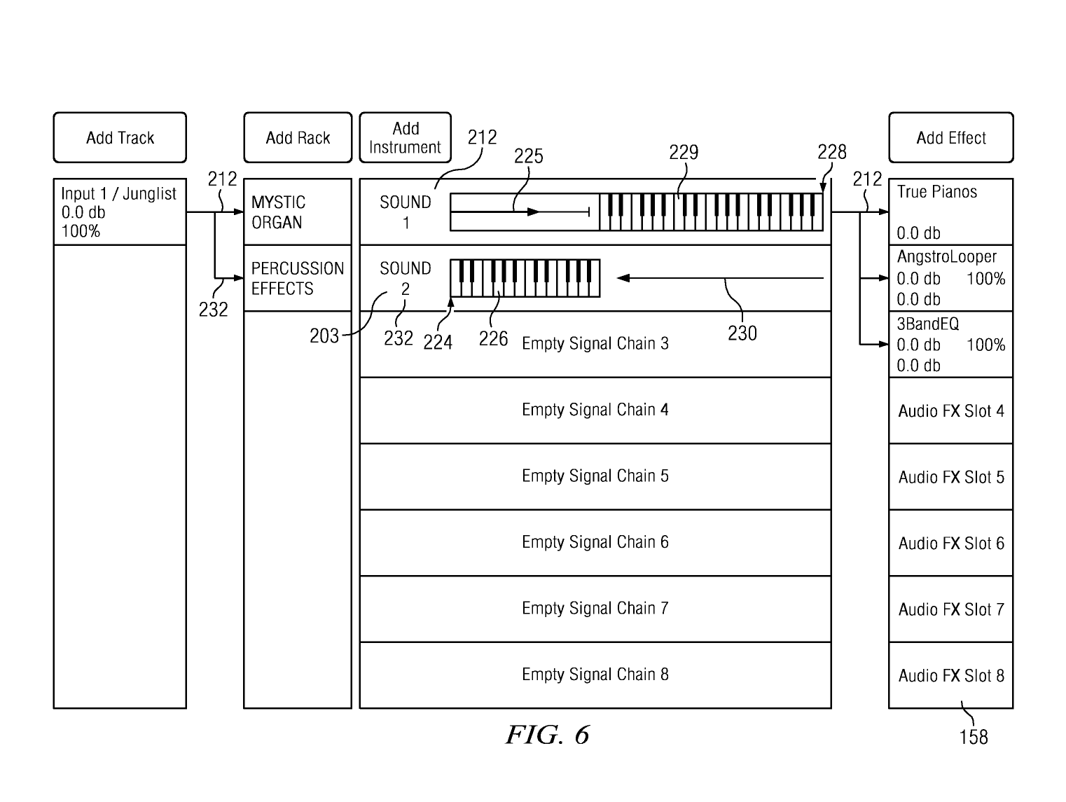

Referring to FIG. 6, in one embodiment, the host software, which provides an exemplary sound chain GUI 180, enables a user to assign a keyboard split by touching or dragging a pointing device from an end 224 of an ivory keyboard GUI 226 on the graphic user interface display 120. For example, touching the left hand end 224 of the ivory keyboard 226 and then dragging the user's finger or pointer device to the right across the keys of the ivory keyboard GUI 226, towards notes of higher tonal values, will select the low group of GUI ivory keys for assignment to one of the selected instruments of the selected signal chain (e.g., percussion sound 2 203). Similarly, dragging a user's finger or pointer device across the ivory keyboard GUI from the right end 228 of the ivory keyboard GUI 229 towards notes of lower tonal values 230 will select that high group of keys to a second selected instrument, such as the sound 1 mystic organ 212. As a result, when the lower note ivory keys are played sound 2 203 percussion sound signals will be produced and heard. Similarly, when the higher tonal keys are played then sound 1 212 mystic organ sound signals are produced and heard via the sound chain shown in FIG. 6. In various embodiments, the different sound chains (e.g., mystic organ sound 1 212 and percussion sound 2 232) may have a keyboard split that overlaps each other such that the same key in the sound 1 and sound 2 chains plays both a sound from the mystic organ sound chain 212 and the percussion sound chain 232. Furthermore, embodiments of the invention allow the keyboard to be split into eight separate distinct sections, such that eight portions of an ivory keyboard 124 of FIG. 1 may each produce or be part of a separate sound chain and/or MIDI controlled device including. Such MIDI controlled devices include, but are not limited to, a lighting system, video system or other MIDI controlled system that is an external audio related device 116 to an embodiment of the invention, as well as various virtual instrument/sound tracks comprised of instrument and, in many cases, effect plug-ins as described above.

Thus keyboard splits are easily visualize by a user because each signal chain and its associated ivory keyboard GUI comprising virtual ivory keys are displayed in the signal chain column of the signal chain GUI screen 180. Each ivory keyboard GUI in a displayed signal chain column 214 of a track may correspond directly to the ivory keys of physical ivory keyboard interface 124. A keyboard split can be created by the user selecting the instrument plug-in in the rack/signal chain column and then selecting a set of contiguous virtual ivory keys or selecting the instrument plug-in in the rack/signal chain column and pressing a first and then a last physical ivory key on the corresponding ivory keyboard interface 124. Meanwhile the signal chain GUI screen 180 and the individual ivory keyboard GUIs will graphically display the keyboard split or splits being created as shown in FIG. 6.

Referring to FIG. 4, the keyboard splits can be established in some embodiments using both a physical ivory keyboard 124 and the set high range control 232 and set low range control 234. A user would press or select the open split control button 236 and then select the set high range control 232. After selecting the set high range control 232, the user would press a physical key on the ivory keyboard 124 indicative of the high range of the split being created. The user will then press or select the set low range control button 234 followed by a pressing of a physical key on the ivory keyboard interface 124 indicative of the lower end of the range for the split being created. This is all done while a particular ivory keyboard GUI, such as sound 1 or sound 2, has been selected on the GUI screen. This alternate technique for creating multiple keyboard splits can be used to create eight individual non-overlapping, partially overlapping or completely overlapping keyboard splits for each of the eight signal chains available in an exemplary embodiment. Embodiments that provide more than eight signal chains for a track will be able to provide at least the same number of keyboard splits as the number of instruments or signal chains in the track.

Referring back to FIGS. 4 and 5 additional detail with respect to the exemplary controls shown in the upper right area of the signal chain GUI 180 is now discussed. A play/toggle button 138 is provided to enable a user to instruct the exemplary music production system to toggle between a play function and a stop function for the sequencer system. The play/stop button 238 initiates the sending of a MIDI start message on play and a MIDI stop message on stop. The sending of this MIDI signal may go to an internal plug-in module that is being utilized or be sent from an exemplary MPS 100 via the MIDI I/O 126 to an external audio device 116 such as a physical synth device or keyboard (not specifically shown). The play/stop toggle button 238, in sending MIDI play and MIDI stop messages to a plug-in sequencer that is loaded into the operating system via the plug-in library 118 will also operate and be applicable to instruments that have built in sequencers and effects that are tempo-synced.

The pause button 240 may be used, touched or selected by a user in order to pause the active sequencer, sequencer plug-in, instrument or other effect as appropriate. The BPM (beats per minute) is an indicator that displays the current global beats per minute or tempo. In embodiments of the invention, the global BPM can be changed or adjusted by a user touching, selecting or clicking on the BPM button 242 and then dragging their finger, mouse, or pointer left/right, up/down, or by tapping or clicking on the BPM display button 242 at the beat or tempo desired. Embodiments of the invention accommodate all of these various techniques for increasing decreasing and adjusting the global BPM of the device.

The main volume 244 is the master output volume knob for the host software 112 and or the overall embodiment of the music product system. This knob works substantially similar to the main volume GUI 160 discussed earlier.

FIGS. 7, 8, 9, 10 and 11 illustrate an embodiment of various configurations of the lower section or portion 246 of an exemplary signal chain GUI 180 displayed on a graphic user interface display 120. The lower portion of the signal chain display 246 is context sensitive and may be switched between the configuration shown in FIG. 5 and the configurations shown in FIGS. 7-11 depending on the item or control that is currently selected in the signal chain GUI 180 by the user as well as by the parameters and controls that are functionally appropriate with the selected item.

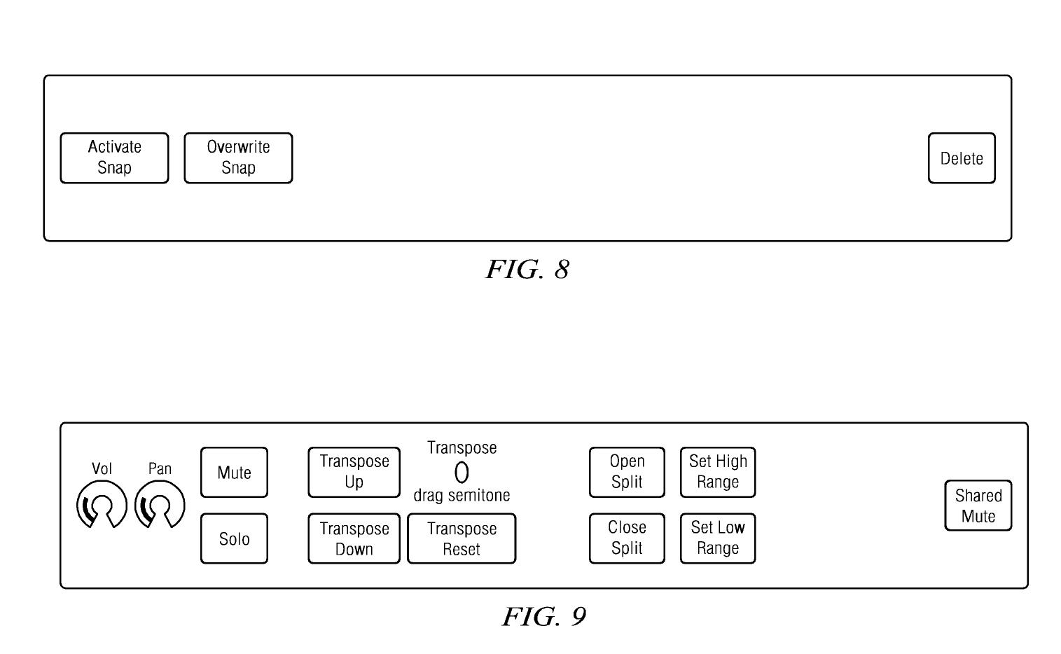

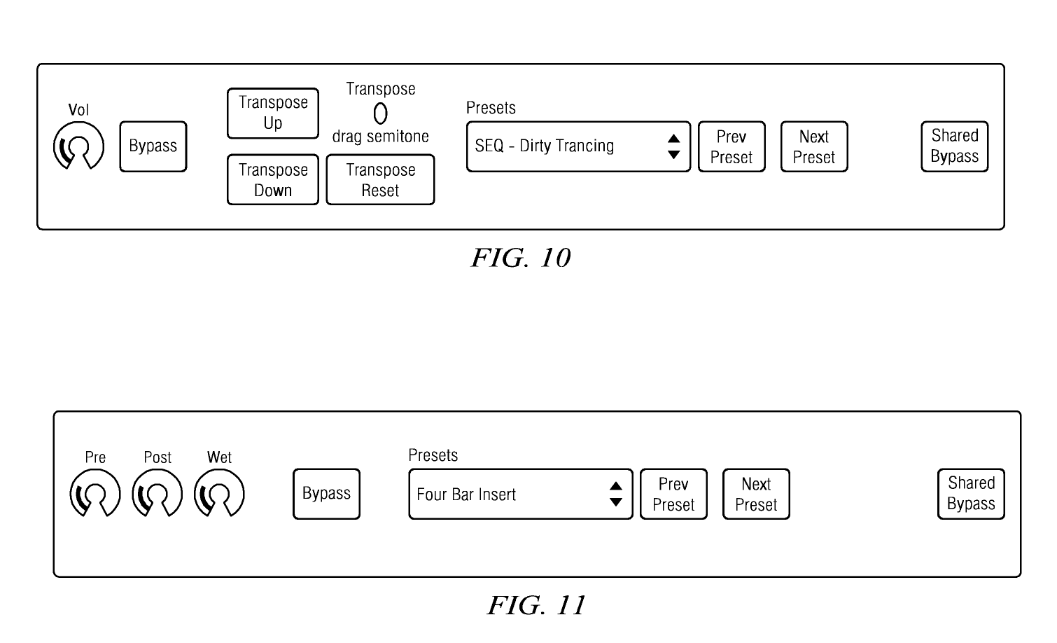

FIG. 7 may be displayed in the lower portion 246 of the signal chain GUI screen when the sequencer track is selected. FIG. 8 is displayed in the lower portion 246 of the signal chain GUI screen when the rack snap shot 210 is selected. The controls of FIG. 9 are displayed in the lower portion 246 of the signal chain display GUI when a specific instrument is selected. The GUI controls of FIG. 10 are displayed in the lower section 246 of the signal chain display GUI when an instrument is selected. Controls of FIG. 11 may be displayed in the lower portion 246 of the signal chain display GUI when an audio effect in the stream processor column 204 is selected.

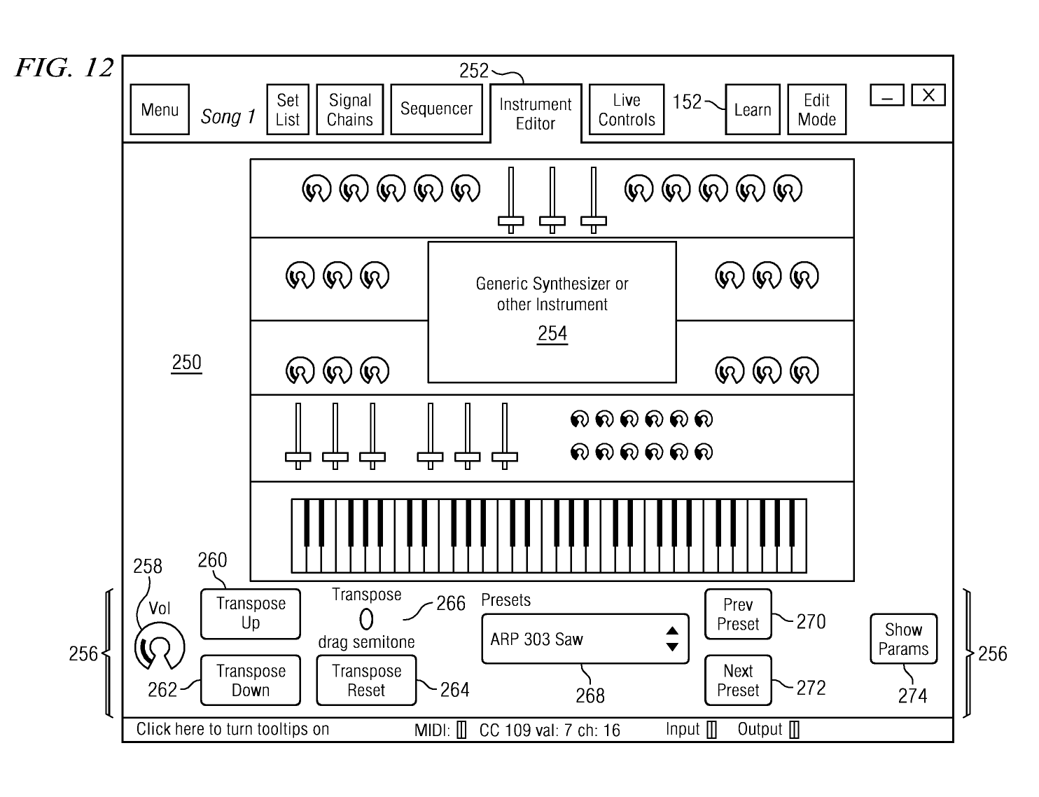

Referring now to FIG. 12, an exemplary instrument editor GUI screen 250 is displayed. Here a user selected the instrument editor tab 252 to instruct the host software 112 to bring forth the instrument editor screen for a selected preset from for example FIG. 2. The instrument editor will also bring up a selected instrument plug-in or effect plug-in that is selected or in focus from the signal stream processor column 204 just before the instrument editor tab 252 is selected or in focus by the user. The title bar tab menu is context sensitive. As such, the tab 252 will dynamically switch between “instrument editor” and “effect editor” as required. Embodiments of the host software 112 will also allow a user to access the instrument editor screen 250 by double-clicking or double tapping an instrument in the instrument rack column 210 or an instrument signal chain in the instrument/sound signal chain column 214. The exemplary virtual plug-in device 254 displayed on the instrument editor GUI screen 250 will vary depending on which VST instrument or plug-in has been currently selected by the user for editing. The virtual plug-in device 254 depicted in FIG. 12 is a generic synthesizer. It is understood that embodiments of the invention are not limited to this virtual generic synthesizer (VST plug-in) and thus any installed instrument or plug-in may be displayed virtually and controlled through the instrument/effect editor screen 250. The virtual plug-in device being displayed 254 may be advantageously graphically represent or emulate the layout of a physical instrument or device so as to facilitate control of the various settings on the device or instrument. The virtual plug-in device 254 is essentially a GUI created by the third party that created the VST software for the same device or plug-in which is stored and found in the plug-in library 118. If the displayed plug-in GUI for the instrument or plug-in is larger than the physical display screen of the instrument editor 250 then horizontal and or vertical scroll bars will be provided on the edges of the screen to allow the user to access any part of the instrument or effect GUI. Again, the instrument editor displays the graphic user interface provided as part of the third party software that represents the plug-in device or instrument developed via VST APIs or direct X APIs.

Regardless of the virtual plug-in device 254 being displayed on the instrument editor screen 250 the bottom portion of the screen 256 may contain controls provided by the host software that may help to ergonomically simplify the use of the third party instrument or effect plug-in GUI displayed on the screen. An instrument output volume control 258 is provided to allow the user to control the amount output that is sent from the displayed plug-in device 254 to the next effect in the active signal chain. The instrument output volume 258 is independent of the volume control for the instrument in the instrument rack column 210. Thus, the instrument output volume 258 merely controls the output volume of the instrument or effect in the selected signal chain that is provided to the next effect in the same signal chain, but is not specifically relative to the overall volume of all the instruments and effects in the selected signal chain.

The transpose up control 260, transpose down control 262 and transpose reset control button 264 may be touched or selected by a user in order to transpose notes sent by the selected third party GUI 254 in the signal chain in increments of a semi-tone. To reset the transposition of the notes back to their original state the user may select or touch the transpose reset control button 264. The transpose display 266 is provided so that the user may see the value by which the input notes are adjusted. For example, −12 would indicate a transposition of 12 semi-tones down. If +24 is shown in the transpose display 266, then that would indicate that the notes have been adjusted up by 24 semi-tones. Again, the transpose reset button instructs the host software to reset the transposition of the notes to zero thereby making it so notes input into the virtual plug-in device being displayed will pass through the device without being transposed.

The preset scroll bar 268 allows a user to view other presets, from the set list screen 180 or presets stored in the memory storage device 108, which use or incorporate the same third party plug-in and GUI 254 being displayed. If the user wanted to set the displayed plug-in device 254 to have the same settings as are used in a different preset, the user can select the different preset via the scroll bar 268 and thereby minimize the amount of work and adjustments that the user needs to perform in order to set the selected virtual plug-in device 254 up as desired. The previous preset control button 270 and the next preset control button 272 aid the user by enabling navigation through a preset list, one preset at a time to help selection of a previously programmed preset that uses the same virtual plug-in device 254 that is being displayed on the instrument editor GUI screen 250. The show params control button 274 allows the user to see a complete listing of all the parameters that are set and or can be adjusted the virtual plug-in device 254. The learn control button 152 near the top of the exemplary instrument editor screen 250 may be activated on the instrument editor screen to learn a parameter on the instrument or plug-in. When the learn control button 152 is selected or touched, the host software 112 goes into learn mode as described herein.

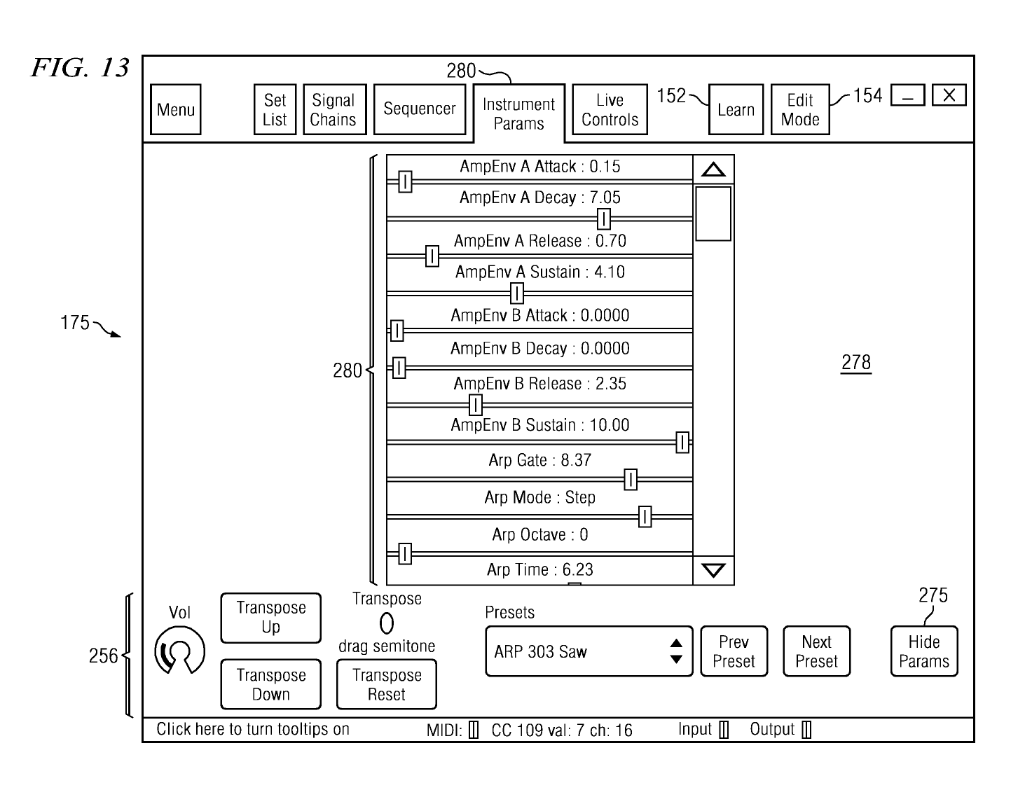

FIG. 13 shows an exemplary display of the instrument parameter GUI 278 when an instrument is selected in the instrument editor screen 250 and when a user selects the show params control button 274, the instrument parameter GUI screen 278 is shown with an instrument params navigation tab 280 at the top of the screen. The title bar tab menu across the top of the screen, as discussed before with respect to the instrument editor/effect editor tab 252, is context sensitive and dynamically switches between instrument params and instrument editor as required depending on the user's selection of the show param 274 or hide param 275 control buttons. In the instrument params GUI screen 278, the list of parameters 280 for the selected plug-in effect or instrument are made accessible to the user. The last touched or selected control on virtual plug-in device 254 displayed in the instrument editor GUI screen 250 will be highlighted on the parameter GUI screen 278. This improvement over generic host software aids a user in locating and adjusting hard to distinguish parameters that are not self evident on a virtual plug-in device's GUI 254. The instrument parameters screen 278 presents a list of the basic parameters for the selected instrument plug-in. The screen may also display parameters that are not accessible from the virtual plug-in device 254 that is displayed on the instrument editor screen 250. The lower portion of the screen 256 may be identical or similar to the lower portion of the instrument editor GUI screen 250.

Like other screens, the learn control button 152 on the instrument parameter screen 278 may be activated to learn a parameter directly from the list of instrument parameters 280 for the selected instrument or plug-in to a user selected MIDI controller or live control object.

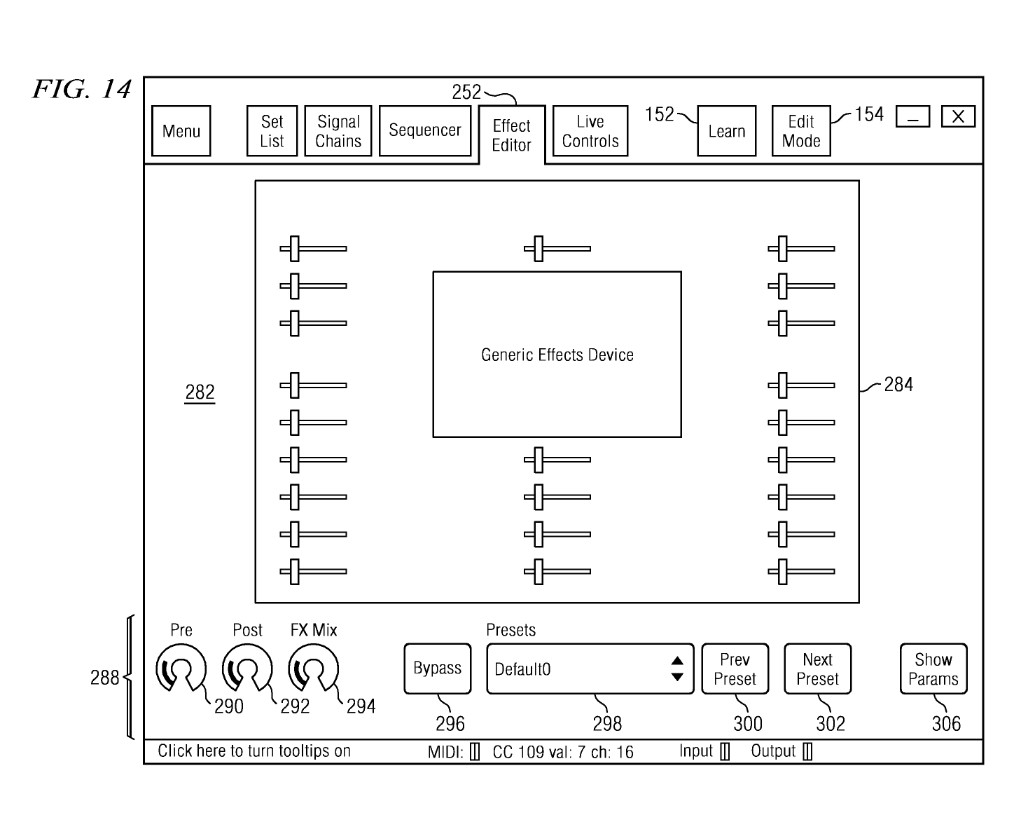

FIG. 14 shows an exemplary effect editor screen 282 as selected by the dynamically switched effect editor/instrument editor tab 252. In this embodiment, the main navigation tabs are context sensitive and may dynamically switch between effect editor, instrument editor, effect params and instrument params as required. If, for example in FIG. 5 an effect or effect plug-in is selected (e.g., reverb effect 196), then a corresponding exemplary third party effect plug-in GUI 284 will be displayed on the exemplary effect editor screen when the effect editor tab 252 is selected or touched by the user. The effect editor screen 282 may also be accessed by double-clicking he desired effect in the signal chain and the stream processor column 204. The effect GUI 284 displayed on the display screen 120 will vary depending on which third party effect plug-in was selected by the user to control. FIG. 14 shows a generic effect GUI device 284, but embodiments of the invention are not limited to this generic effect GUI as any VST API or Direct X API effect device that is installed and stored in the memory storage device 108 within the plug-in library 118 may be controlled through the effect editor screen 282. The effect editor screen 282 may advantageously and graphically represent or emulate the layout of a physical effect device so as to facilitate a user's understanding of its control. If the effect GUI for the effect plug-in is graphically larger than the physical screen of the user interface's display 120, then horizontal and or vertical scroll bars will allow the user access to any part of the displayed effect GUI 284.

In embodiments of the invention, the host software 112 may provide one or more additional controls on the effect editor screen 282 along with the effect plug-in GUI 284. These additional controls will now be described and are found in the bottom portion 288 of the exemplary effect GUI screen 282. These controls, which provide additional ergonomic advantages to a user when adjusting or setting an effect or plug-in GUI may in include, but are not limited to the following exemplary individual controls. The pre control 290 is used by a user to effectively amplify or attenuate the amount of input being received by the selected effect or plug-in 284. The post control 292 allows a user to control the output intensity or volume of the processed signal that has passed through the selected effect or plug-in 284. The FX mix control is a wet/dry mix that enables the user to adjust how much of the original virtual unprocessed signal is mixed with the virtual effected signal at the output of the effect plug-in. The bypass control button allows a user to leave the selected effect in the signal chain, but deactivates the selected effect plug-in such that a data signal entering the plug-in remains unprocessed or bypasses the deactivated effect plug-in. The presets scroll bar 298 displays the list of presets contained within the synth. Touching or selecting the preset name in the preset scroll bar 298 will expand the list into a scrolling list where a user may select a different preset. The previous preset 300 and the next preset control button 302 have substantially the same functionality as the previous and next preset control buttons 270 and 272, respectively, discussed above. The show params/hide params control button 306 operates similarly to the show params button 274 explained above.

The learn control button 152, found on both the effect params GUI screen 308 and the effect editor GUI screen 282 may be selected or activated by a user to direct the host software to learn a parameter of the effect or effect plug-in. When the learn control button 152 is touched or selected the host software 112 will enter into learn mode.

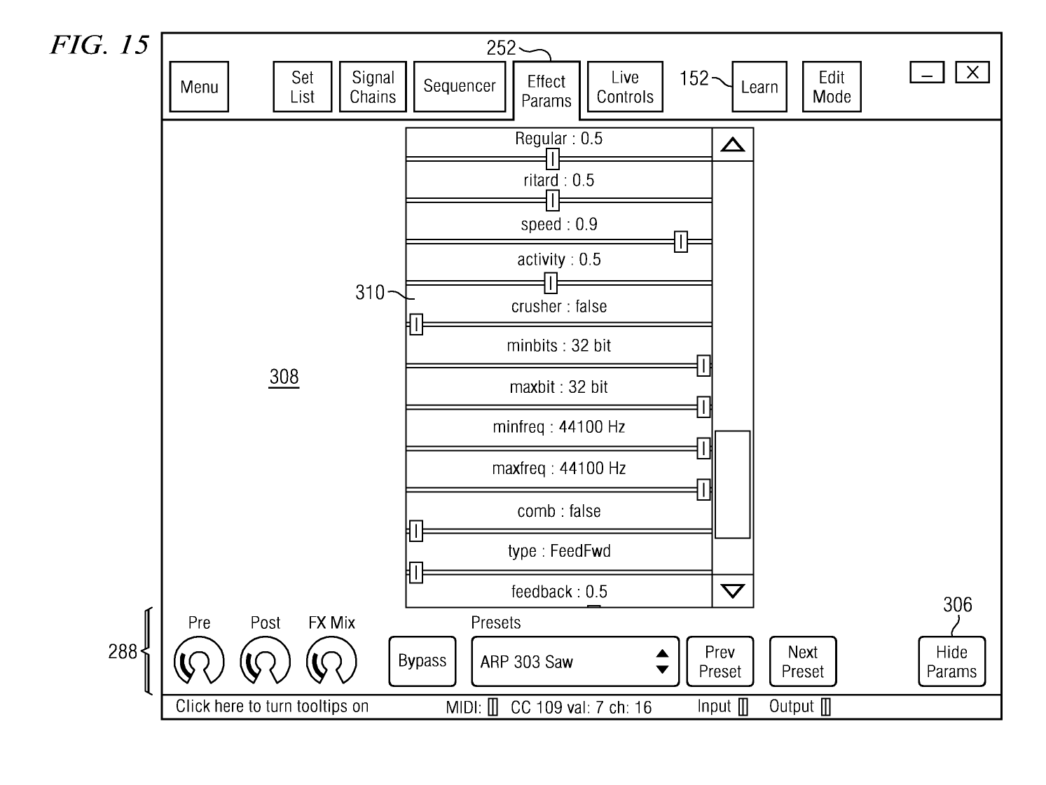

In FIG. 15, in the effect parameter GUI 308, the navigation tabs of an embodiment may be context sensitive and will dynamically switch between effect params, effect editor, instrument params and instrument editor as required. If an effect or effect plug-in is selected from the signal chain by a user, in the associated third party effect GUI 284 may be displayed. When a show params control button 306 is pressed, then a list of effect parameters 310 for the selected effect plug-in are displayed on the effect parameters GUI screen 308. The last touched control on the effect GUI 284 will be highlighted on the effect parameters GUI screen within the list of the effect parameters 310 fully selected effects plug-in. This ergonomic advancement aids a user in locating hard distinguish effect parameters. The effect parameter GUI screen 308 presents a list of the basic parameters for the effect or effect plug-in selected. Furthermore, parameters that are not accessible the controls depicted on the effect GUI 284 may also be displayed and included in the list of effect parameters 310. Like the effect editor screen 282, the effect parameter GUI screen 308 may have an area such as the lower area 288 that displays host generated controls that were also provided in the same or similar area of the effect editor GUI screen 282.

The learn control button 152 may be selected by the user to place the host into learn mode such that any one or more of the effect parameters displayed on the effect parameter GUI screen can be learned or attached to a MIDI controller or live control object as will be explained in more detail below. Referring for a moment to FIGS. 12 and 14, it is noted that although the displayed exemplary instrument plug-in GUI 254 and the effect plug-in GUI 284 appear on their face to be relatively easy for a user to adjust the various control parameters using the sliders, knobs buttons, etc. displayed in the representative GUI, during a live performance is more often cumbersome and usually impossible to do with accuracy and ease. Thus, embodiments of the invention provide a user, via the host software 112, an ability to create and establish live controls that may be created in association with a particular preset or presets. Such live controls can be color coded, placed, sized, or reconfigured such that a user may easily adjust predetermined ones of controls for any instrument or effect in any track within a predetermined preset during a live performance. This is a significant advancement in the art as a user is now able to adjust any predetermined setting or parameter ergonomically and easily via on-screen user created MIDI controllers or via physical MIDI controllers such as sliders, knobs, buttons, or otherwise found on the control modules 128 of an exemplary embodiment.

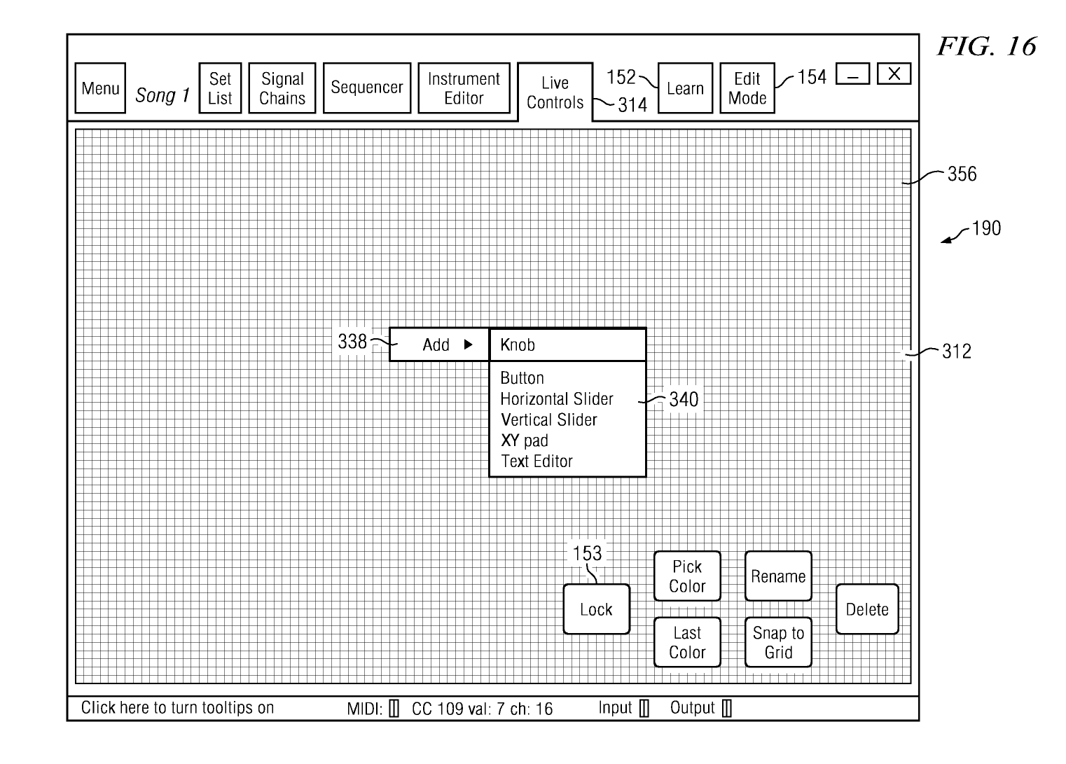

FIG. 16 depicts an exemplary live control screen 312 generated by the host software and displayed on the graphic user display 120. The live control screen 312 may be summoned by a user by touching or selecting the live controls navigation tab 314. The live control screen provides an environment where a user may create a custom set of local input or MIDI controllers that can be learned and linked to any instrument, effect, signal chain, control or parameter associated therewith that is contained within a selected preset of a selected set list. Live controls for a preset are saved with its related preset in the database 130 preset and may be recalled by the host software from the database 130.

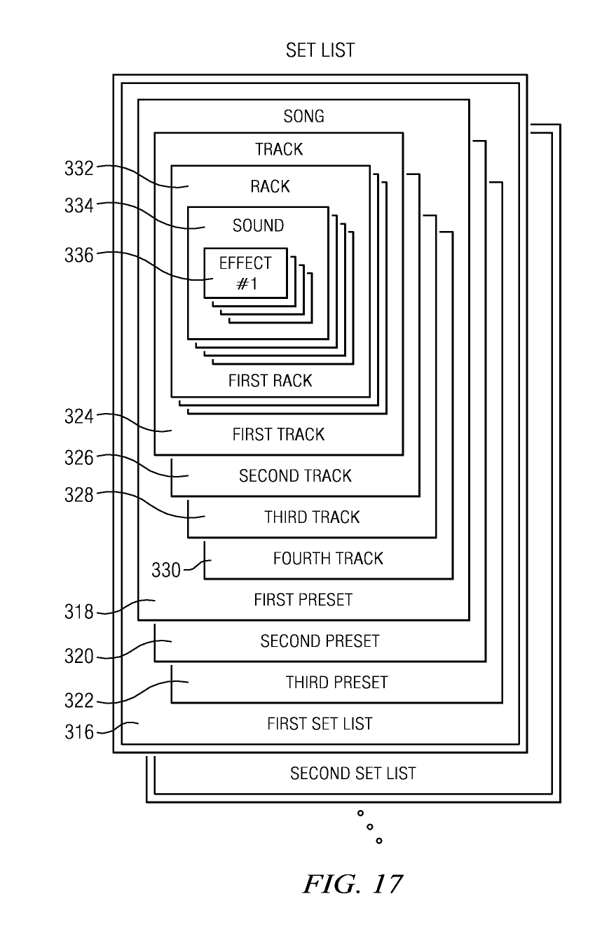

Referring for a moment to FIGS. 1, 2, 5, and 17 a general exemplary database structure 130 used by the host software 112 will be described. Each preset 138 on the set list GUI screen 132 represents the electronic set up or virtual electronic set up associated with a song or portion of a song or a performance. For example the set list GUI screen 132 displayed in FIG. 2 may represent a first set of preset songs or performances 316. In the database 130, the first set list may comprise a plurality of presets for example a first preset 318 a second preset 320 and a third preset 322. The embodiment shown in FIG. 2 indicates that a set list may have up to 110 presets. Though various embodiments of the invention may allow for more presets, each preset 318, 320 and 322 represent a virtual and or physical set up for a song or performance. When a performance is recorded in a recording studio, the performance may be recorded in a plurality of tracks. Embodiments of the invention use the track nomenclature in a similar manner as a studio, but a track may also include virtual instruments and effects. Thus, as shown in FIG. 17 the first preset contains a first track 324, a second track 326, a third track 328, and a fourth track 330. The first track 324 may be for example the lead guitar track the second track 326 may be for example the vocal track the third track, 328 may be, for example, the bass guitar track and the fourth track 330 may comprise a keyboard or any other external audio device 114 or external audio related device with MIDI I/O 316 or any plug-in instrument from the plug-in library 118. All such tracks may comprise up to eight instruments in their rack. For example, the first rack 332 may coincide with the FIG. 5 track 1 184 rack containing two different instruments in the rack column 210. Each musical instrument in the rack column 210, 332 will have stored in the database memory an associated sound 334, 194. Each sound in the database may have a plurality of effects. In FIG. 5, there is a reverb effect 196 and an echo effect 198 in the signal chain after the organ plug-in sound 194. FIG. 17 shows effect number 1 336 and perhaps additional effects stored with respect to the first sound 334, which is stored in memory with respect to the first rack 332, which is stored in memory with respect to the first track 324 of the first preset 318 within the first set list 316. Thus, the database 130 within an exemplary MPS 100 stores a plethora of related plug-ins and their preset control settings, which establish the virtual studio that can be reconfigured by a user with less than a second of delay time when the user touches or selects a preset in an active setlist on the setlist GUI screen 132.

It should be understood that the effect data 336 may be stored without being specifically linked to a sound 334 track 324 preset 318 or setlist 316. In fact, data for each level in the database hierarchy of FIG. 17 may be stored separately or within the prescribed hierarchy of setlist, preset, track, rack, sound and effect.

Referring back FIG. 16 and the live control screen 312, on the live control screen the user may use the host software 112 to custom build a set of local input of MIDI controls that are viewable on the live control screen 312 and be linked and learned to the controlled parameter of any instrument plug-in, effect plug-in or any signal chain control contained within a preset of an active setlist. Live controls (not specifically shown in FIG. 16) associated and stored in a database 130 are saved within or in association with the preset that it is created for, such that the user created live control can be easily recalled via the host software.

Each of the user created live controls can also be set to send a specific MIDI CC message. When a MIDI device driver is selected as a MIDI input in the MIDI tab of the Options dialog from the main menu, the MIDI CC messages generated by movement of a live control can be sent to another MIDI enabled application running on the host machine 100. The other MIDI enabled application will have one of its available MIDI drivers selected as its MIDI input. The predetermined direct driver in the MPS sends the MIDI CC messages, which were generated by movement of the live control, to the MIDI drivers for use as input. This configuration allows the user of an exemplary MPS a flexibility of creating interfaces that control multiple applications running on the same host machine, yet from one user designed interface. For example, this configuration can be used to create an interface using the live controls of an exemplary MPS to control a MIDI enabled video playback program and/or MIDI controlled lighting system along side (on the GUI screen, control modules, or an ivory keyboard of the MPS) live controls, control modules and/or an ivory keyboard that is being simultaneously used to control instruments and effects in the MPS. By also selecting one of the hardware MIDI output ports of the host machine (i.e., the machine on which the MPS software is running) a standard MIDI cable can be used to electrically connect other external hardware devices 116. As such, MIDI messages generated by the live controls can be sent via the MIDI I/O 126 and be used to control external hardware devices or interact with software operating on a device external to an exemplary MPS. Thus, embodiments consolidate MIDI control for various applications and external devices in to one user defined GUI interface (live control screen). The applicant is very aware of competing innovations and remains unaware of any other programs or applications that bring a user defined GUI, control of external or outbound MIDI enabled device or applications, control of concurrently running separate MIDI enabled applications on the same processor or host computer, and an associated data pipeline all in one complete host software package.

The edit mode/live mode control button 154 toggles the edit/live control GUI screen 312 between edit mode and live mode. In edit mode, the host software 112 enables and allows a user to add, remove, resize and edit the properties and parameters of the live control. In live mode, which is used during a live performance, the user created live controls on the live control screen 312 control their assigned track, rack, sound, effect, and/or signal chain parameters directly when a user touches or interacts with a user created live control. Each of the user created live controls (a “live control object”) may be mapped or attached to a plug-in's parameter and may adjust that plug-in's parameter as if the plug-in was being displayed in the instrument or effect GUI screens and as if the parameter were hardware controlled.

A left click, right click or user touch of the graphic user interface display 120 while the host software is displaying the live control screen 312 and is in edit mode will bring up an add menu 338. The add menu has a drop down menu allowing the user to select from various live control object types for user definition. The various live control object types that a user may select from include knobs, buttons, horizontal sliders, vertical sliders, XY paths. In some embodiments, the host software provides a user definable live control object along with a text editor for labeling the user created live control object.

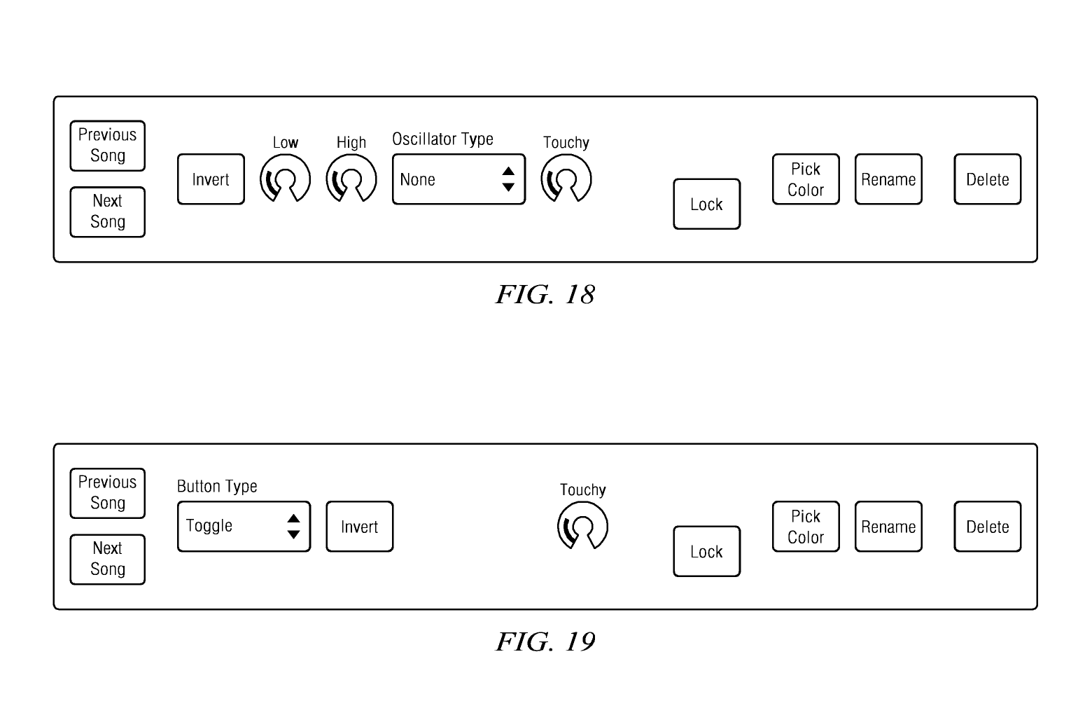

One of the live control objects selected may be a knob. If a knob is selected from the drop down menu 340, then FIG. 18 provides exemplary property controls that the host software 112 may provide a user for defining the knob properties. The live control knob properties may include at least:
i. Name—The user may change the name of the live control knob object as it appears on the live control screen 312.
ii. Invert—This option allows the user to invert the live control knob object function.
iii. Low and High—The low and high boundaries of the knob object can be set. Furthermore, low and high boundaries for how much the knob can rotate and how quickly the knob may rotate when used, as well as the ratio between the object knob's movement and the movement of the emulated plug-in GUI knob can all be user defined.
iv. Oscillator Type—the user can use the oscillator type setting to make the knob oscillate at a user defined frequency. The oscillation may be synced to the beats per minute (BPM) of the selected song/preset. The oscillation type may be selected by the user to include, but not be limited to, no oscillation, sin, linear oscillation, saw tooth, inverted saw tooth or square wave oscillation. For each oscillation of the user defined knob object the period of the oscillation and the range of oscillation motion can be user adjusted and set.
v. Touchy—The user can set how quickly a knob object responds when touched. Sometimes, touchy may be referred to as a knob's sensitivity to a user's touch.
vi. Lock—When lock is activated, the live control's positions on the GUI screen cannot be moved or have their sized changed, yet the live controls may be effectively moved and controlled by a user.
vii. Snap—When activated, snap allows a live control to be aligned to the display grid. This allows the user to create uniformly spaced or positioned live control layouts.
viii. Pick Color—When a user selects the pick color control button, the host software bring sup the color picker box which allows the user to select a color for the user created control object.
ix. Rename—Selecting the rename control button directs the host software to allow the user to change the name of the user-created knob object as it appears on the live control screen 312.
x. Delete—Selection of the delete control button deletes the currently selected live control knob object.

A user may create a user-defined live control button object by selecting the button item on the drop down menu 340 in FIG. 16. When a user selects button in the drop down menu 340, a variety of button property controls may be displayed by the host software on the graphic user interface and display screen 120. FIG. 19 shows an exemplary embodiment of the various button object property controls that may be available in an exemplary embodiment. The button properties may include at least:
i. Button Type—The user may select a variety of different button types including, but not restricted to, a toggle button type wherein the button remains triggered until pressed again, a momentary button type wherein the button triggers when pushed and releases the trigger when released. The button may also be a timed momentary button wherein the button triggers for a user defined period when selected or touched. Various other types of button objects may be made available in embodiments of the invention.
ii. Invert—When invert is selected by the user, the button function is inverted.
iii. Lock—When lock is activated, the live control's positions on the screen cannot be moved or their size changed, yet the live controls remain adjustable or controllable by the user.
iv. Snap—When activated, snap allows a live control to be aligned to the display grid. This allows the user to create uniformly spaced or positioned live control layouts.
v. Color—When selected, pick color brings up a color picker box allowing the user to select a color for the control.
vi. Rename—When selected the user may rename or change the name of the user created button object that appears on the live control screen 312.

If a user selects the horizontal slider or vertical slider elements on the drop down screen 340, the user may select from at least the following slider properties:
i. Movement Control—The user may define the low and high boundaries of the slider. Furthermore the user may set the length of movement and how quickly the slider can move when interacted with in live mode. Furthermore, the user may set the ratio between the slider movement and the movement of the emulated plug-in slider knob or other moveable control parameter.
ii. Oscillator Type—The user may set a slider to self oscillate. The user may set the oscillation to be synced to the BPM of the selected song/preset. The oscillation types may include, but are not limited to, no oscillation, sin, linear, saw, inverted saw or square wave oscillation. The user may also define for each oscillation the period for the oscillation and the range of the oscillation.
iii. Touchy—When the touchy control button is selected, the user can determine how quickly or easily the slider responds when used in live mode. Touchy is sometimes referred to as sensitivity to a user's touch.
iv. Lock—When lock is activated, the live control's positions on the GUI screen cannot be moved or their size changed, yet the live controls may continue to be used and controlled by the user.
v. Pick Color—When selected, the pick color control button brings up a color picker box on the screen that allows the user to select a color for the control object being created or edited.
vi. Rename—When selected, the rename control button allows the user to create or change the name of the slider as it appears on the live control screen 312.
vii. Delete—When selected by the user, the delete control button deletes the currently selected vertical or horizontal slider.

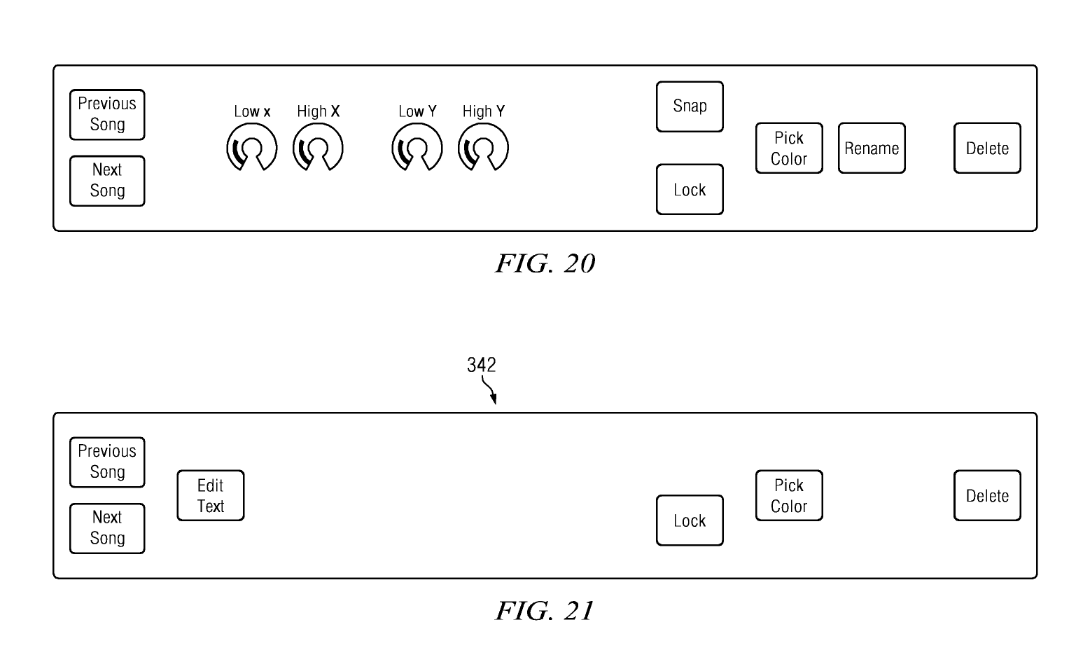

If a user selects the XY pad from the drop down menu 340 of the live control screen 312 while in edit mode, a plurality of XY pad property controls will be displayed by the host software on the display screen so that the user may define the XY pad live control object. FIG. 20 depicts some exemplary XY pad property controls. An XY pad object is designed to be used with a user's finger pressed against the XY pad on the graphic user interface display 120. An XY paid may be positioned anywhere on the live controls screen 312. The XY pad object properties may include at least:
i. X Values and Y Values—The user, via the host software, may set the low X and Y as well as the high X and Y boundaries of MIDI values that are sent for both the X and Y axis when a user is touching the XY pad.
ii. Physics—A module in the host software, the seeker pixel velocity module, allows the user to set how quickly the XY pad object follows the user's movement from an initial location of the XY pad to a new location on the XY pad object. Lower values of seeker pixel velocity equate to slow movement and higher values equate to faster movement or following of the user's movements on the XY pad. A user may select maximum velocity override, which ensures that the seeker pixel velocity software module is always set to the maximum value such that there is no lag or trail between the user's finger movements on the virtual XY pad object on the graphic user interface display 120 and the controlled output or MIDI output of the XY object with respect to real time.
iii. Touchy—Selection of the touchy control button by the user allows the user to set how quickly a XY pad object responds when used. Touchy is sometimes referred to sensitivity to a user's touch.
iv. Lock—When lock is activated, the live control's positions on the GUI screen cannot be moved or their size changed, yet the live controls may continue to be used and controlled by the user.
v. Pick Color—User selection of the pick color button control brings up a color picker box allowing the user to select a color for the virtual XY pad object displayed on the live control screen 312.
vi. Rename—Selection of the rename control button allows the user to change the name associated with the selected XY pad as it will appear on the live control screen 312.
vii. Delete—Selection of the delete control button deletes the currently selected virtual XY control pad object.

In additional embodiments, the virtual XY pad object may be freely positioned and sized on the live control screen 312 as desired by the user. The snap control button may allow the user to snap the virtual XY pad object to a position on the grid 356 provided in the background of the virtual control screen 312. A large pad may be advantageous for fine control of certain user selected parameters. A smaller pad may be created for tap or drum pads, which do not require such fine, control as other parameters. A user may create an assign a plurality of XY pads, each of different size, shape and position on the live control screen 312.

If in FIG. 16 the user selects the text editor in the drop down menu 340, a plurality of text editor controls 342 may be viewed by the user as shown in FIG. 21. The text editor creates a text box where the user may input notes, text, or labeling associated with one or more of the user created virtual control objects. Multiple notes, text or labels may be placed on the live control screen 312 to help remind the user of the name of a song, special tricks related to a song, the parameters being controlled by the virtual control object or any other notes that the user may want displayed on the live control screen 312 during a live performance. The text editor controls 342 may include, but are not limited to, allowing the user to adjust font size, editor or change the text that is displayed in a live mode, lock down all live controls, pick the color of the text being displayed, rename the name of the text as it appears on the live control screen and, of course, delete the currently selected text.

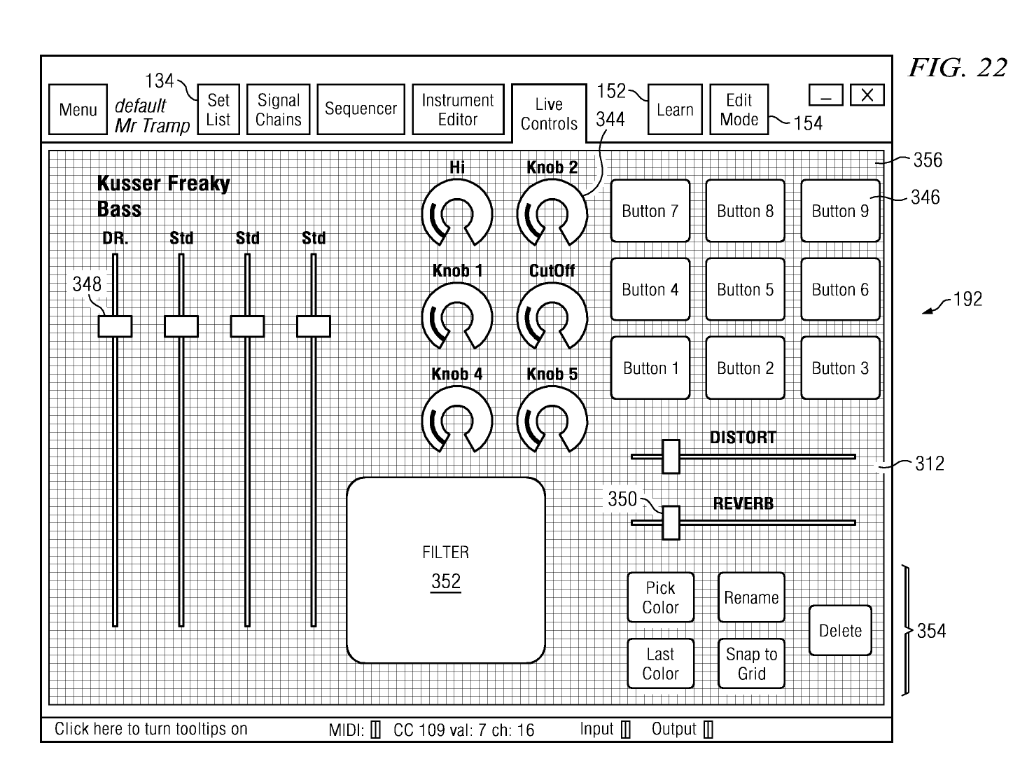

FIG. 22 depicts an exemplary live control screen 312 wherein a user has created a plurality of live control objects. Such live control objects include knobs 344, buttons 346, vertical sliders 348, horizontal sliders 350 and an XY control pad object 352. Although FIG. 21 is shown in black and white, the color of the various user created control pad objects in FIG. 21 can be selected and varied by the user. For example, the user may wish to make all synth controls red while making all volume controls blue. The position, sizing, color and labeling of each object is determined by the user in order to provide the best ergonomic functionality for the preset or song for which the particular live control screen is created. Live controls are saved in the database 130 on a per-song or per-preset basis. Furthermore, user created virtual control objects can be saved individually by the user in the database for recall and use in a variety of presets or songs. The live control screen 312, while in edit mode, enables a user, via the host software, to create a virtual control panel of any desired layout and complexity to control virtually any parameter associated with an instrument plug-in or effect plug-in within a signal chain of a track in a preset or song. A user no longer must move away from their ivory keyboard and reach toward a physical electronic device located on stage, find a particular knob or slider on that device and adjust it to change a needed sound or effect in a live performance. Instead, with embodiments of the invention, the user may have the live control screen set to contain the particular parameter that may need adjusting during a preset performance of a song such that while the song is being performed live, the user may merely touch the graphic user display 120 and adjust the predetermined virtual control object, on the fly, without delay and without getting up during the live performance of the preset or song.

While the host software has the live control screen 312 in both edit and unlocked mode, as depicted in control button 154 and unhighlighed (bolded) lock button 153, the user may resize any of the individual live control objects displayed on the live control screen 312 by clicking and grabbing an edge of any live control object and dragging it thereby making the control object larger or smaller. The user may lasso multiple live objects and move them together as a group about the live control screen 312. Pressing and holding the CTRL key on the keyboard interface 122 while dragging an object may create a copy of the selected virtual control object. Right clicking, with a mouse or other pointer device, on a live control object may bring up the live control item menu (not specifically shown), which may contain but is not limited to containing the following selectable constructions.
i. Properties—Selection of properties on this live control item menu will bring up the properties dialog for the selected live control object on the live control screen.
ii. Learn—Selecting the learn instruction puts the host software into learn mode.
iii. MIDI CC Output—Selection of MIDI CC Output opens a dialog box that allows the user to set the MIDI CC message that is output by the live controls. In an exemplary embodiment, the output MIDI CC message can be set to any value from, for example, CC1 through CC127 or to a NO CC output. A desired MIDI channel ranging from, for example, channel 1 through 16 may also be set. The value generated when the associated live control is used is sent through the selected CC and on the selected MIDI channel to the MIDI out port(s) established by the MIDI options dialog.
iv. Cut—Selection of the cut instruction copies the selected object to a clipboard storage within either the RAM 104 or the memory storage device 108 and deletes the selected object. This is a similar behavior as the Microsoft Windows cut command. After a cut is made, a paste option is added to the right click menu showing that there is an object in the clipboard ready to be pasted onto the existing or another live control screen for a different preset.
v. Copy—Selection of the copy instructions copies the selected object to the clipboard storage found within either RAM 104 or the memory storage device 108. This is a similar behavior as that found in Microsoft Windows copy command. After a copy, a paste option is added to the right click menu showing that there is an object in the clipboard ready to be pasted on the same live control screen or another live control screen that the user navigates to via the navigation tabs (e.g., the setlist navigation tab 134).
vi. Delete—Selection of the delete instruction by the user deletes the selected live control object.

The host software 112 may have instructions that provide a plurality of standardized live controls that are found on every live control screen 312 regardless of the preset with which the live control screen is associated. A predetermined area 354 of the live control screen may contain, but not be limited to, the following controls:
i. Snap to Grid—When snap to grid is selected by the user, the active live control object will align to and snap to the background grid 356. This is useful for lining a plurality of buttons 346 or knobs 344 into an organized array of live control objects on a live control screen 312.
ii. Rename—Selection of the rename control provides the user quick access to the rename option for the live control object.
iii. Pick Color—selection of the pick color button brings up a color picker dialog box. Here, the user can select the color choice for the active live control object.
iv. Last Color—Selection of last color will change the color of the selected live control object to the same color that was last selected for a previously selected live control object. The user may then select another live control object on the live control screen 312 and it will be set to the same color.
v. Delete—Selection of delete deletes the selected live control object.

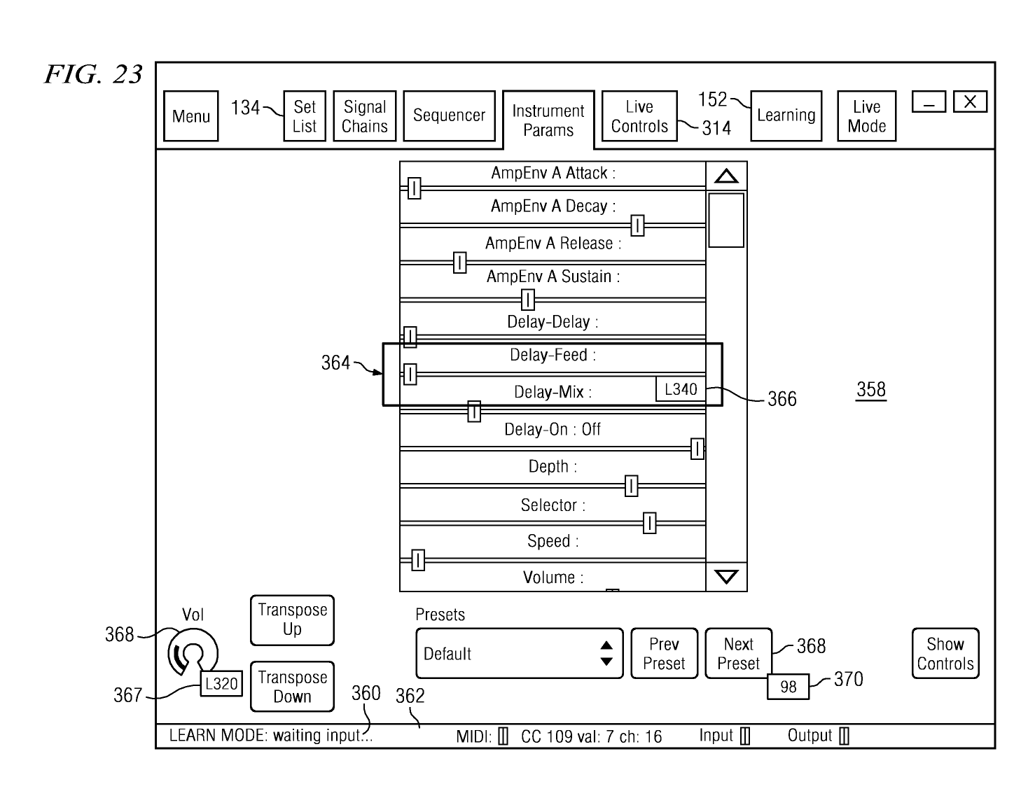

FIG. 23 depicts an exemplary instrument params screen 358 when the host software has been placed in learn mode via the selection of the learned control button by the user which is displaying the word LEARNING 152 in the exemplary instrument params screen 358. An advantage of embodiments of the invention is the simplicity by which a user may bind an instrument, effect plug-in parameter and any host control to hardware, sliders, buttons, knobs or other MIDI controllers found on the control surfaces of the control modules 128 or to any user created live control object displayed on a live control screen 312. The method or steps of using learn mode to bind or attach a hardware MIDI control or live control object to substantially any parameter of a plug-in instrument, effect or host software control is as follows. The learned mode host software instructions can be engaged by a user by selecting the learn button 152 on the title bar of substantially any host generated display screen that is displayed on the graphic user interface and display 120. Such display screens include the set list display screen, the signal chains display screen, the sequencer display screen, the live controls display screen and others. Learn mode may also be engaged by a user when right clicking with a mouse on an on-screen control object.

In some embodiments, when the host software is operating in learn mode, the background of the screen displayed on the graphic user interface display 120 may turn red or another predetermined color in order to provide an obvious indication to the user that the host software is in learn mode. In some embodiments, an indication of the host software being in learn mode 360 may appear in the status bar/tool tip window 362 or other specified location on the display screen with an indication that the host is in learn mode and is awaiting input. In some embodiments, the parameter to be learned from a MIDI signal is first selected and highlighted by the user. At this point, the host software, while in learn mode, is waiting for the next MIDI controller command (CC) to be received or acknowledged by the host software. Upon the next MIDI CC being received by the host software, the host will latch that MIDI CC to the highlighted parameter. For example, suppose a user wished to use the learn mode to bind or latch the delay feed parameter 364 of the instrument params screen 358 depicted in FIG. 23. To a physical slider located on the control surface of a control module 128 of FIG. 1. The user would select learn mode via that learn mode control button 152 and highlight the feed delay slider 364 displayed on the instrument params screen 358. The host software is now waiting for receipt of the next MIDI CC signal. If the user now moves a MIDI slider on a control surface of a physical control module 128, a MIDI CC will then be received by the host software. Upon receipt of the MIDI CC, the host software will latch that MIDI CC associated with the moved MIDI controller slider to the highlighted delay feed parameter 364 that was selected by the user.

A live control object on a live control screen associated with a particular preset may also be learned in a similar manner as a physical MIDI hardware control. For example, if the user wanted to latch or bind the delay feed parameter 364 to the slider 350 shown in FIG. 22, the user would first select the delay feed parameter 364 after placing the host software in learn mode via control button 152. The user then navigates via the navigation set list tab 134 and/or live control navigation tab 314 to get to, for example, the live control screen 312 or a selected preset. The user may then touch or use the mouse or other pointing device to make, for example, live object knob 344 move. The movement of the live object knob 344 will latch the MIDI CC associated with the virtual live control knob object 344 with the feed delay 364 that was displayed in the instrument params screen 358. Thus, the live control 344 will be latched to the highlighted delay feed parameter 364. After the host software receives the movement input of the virtual live control knob object 344, the screen background will revert to its normal color, thereby signifying that the link between the two controls has been successfully made and stored. The MIDI CC number 366 will appear next to the previously learned parameter. In some embodiments, after the user places the host in learn mode, the order of touching or selecting the parameter to be learned and the MIDI hardware controller or live control object is not important. For example, if the learned control button 152 is selected while the user is viewing the live control object screen 312, the user may touch or select a control knob 344 and then navigate the GUI display screens to a instrument or effect plug-in (or its associated parameter screen) and select the parameter to be linked or bonded to the live control knob object 344 or vis-á-vis.

Still referring to FIG. 23, the next preset control button 368 has been latched to a controller sending MIDI CC #98 as indicated by display box 370. When a control is tied to both a live control and a MIDI CC, the live control number and the MIDI CC number will both be displayed next to the control, which is illustrated by the instrument plug-in volume knob 368 being latched to live control and MIDI CC number 320 as indicated by display box 367. The user may latch or bind a MIDI hardware control to both a live control object and a parameter so that the parameter may be controlled from either the live control screen or the physical hardware controller. Latching or binding a parameter to both a hardware controller and a live control object provides the user additional flexibility when the host is operating in live mode during a performance.

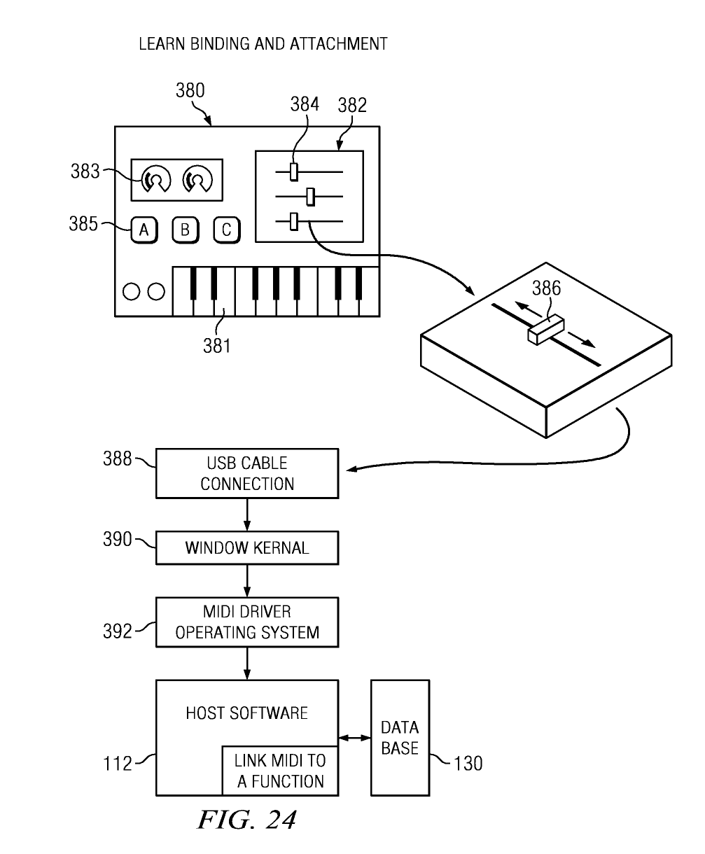

FIG. 24 depicts an exemplary method of latching physical hardware controllers to parameters of plug-ins, controllers, or other on screen control limits. An exemplary exterior of an exemplary music product system 380 is depicted. The exterior of the exemplary music production system 380 provides a variety of physical controls to which a user may interact. For example, a physical ivory keyboard 381 may be provided along with physical volume knobs 383 and various types of buttons 385. The exemplary music production system 380 may have a control module 128 that has a control surface 382. The control surface 382 will have physical hardware controllers that may include a slider 384. Such hardware controllers could include knobs 383, buttons 385, XY pads, cross-faders or other physical controllers. A physical controller 386, such as a slider, may be part of a control module 128 or be part of an external audio device with the I/O 116. A physical controller 386, such as a slider, may be part of a control module 128 or be part of an external device with MIDI I/O 116. The hardware control module 386, whether it be a slider, knob, cross-fader, XY pad, button, touch pad, keyboard, or drum pad (with or without acceleration) or other hardware control device, the user may decide that one of the hardware controllers 386 is to be learned, attached or bonded to one of the thousands of potential parameters associated with the host software screen displays or plug-ins from the plug-in library 118. Thus, the user may link or bond a hardware controller 386 to substantially any module, for example, any song, track, rack, signal chain, individual plug-in, any of the parameters or screen control buttons all of the effect mixes, any wet/dry control, any of the hundreds, if not thousands, of parameters associated with an instrument plug-in or effect plug-in, to change parameter values on the fly or during live performances, to change entire preset configurations, an entire track configuration, an entire rack configuration, and/or any entire sound and/or effect signal chain configuration.

Embodiments of the invention having control modules 128 with one or more hardware controls thereon (e.g., slider, knob, button or other hardware control device 368) have circuitry designed thereon or therewith (not particularly shown) providing a USB standard data and cable connection 388. The hardware controller 386 may provide MIDI information within the USB bus confines. The USB cable connection 388 may be connected into the audio processing microprocessor and computer electronics 102 motherboard. The motherboard receives the MIDI signals via the USB connector and bus and utilizes the MS Window kernel 390 of the operating system 110 that is being utilized by the audio processing microprocessor and computer electronics 102 on, for example, the motherboard to provide the MIDI driver 392. The MIDI driver or drivers 392 operate in conjunction with the operating system and effectively wait for a hardware or live control object having an appropriate address to send a MIDI signal to the MS Window kernel 390. When a MIDI driver 392 is in receipt of a MIDI signal indicating a physical controller 386 (or in various embodiments, a live control object is providing a MIDI signal in response to a user's physical movement of the hardware controller or physical touching of a live control object), then the driver interprets specifically which hardware controller or live object controller is producing the MIDI signal. Then, via the host software 112, the MIDI signal linked to an attached or bonded to a parameter or other control button, etc. in accordance with the stored user defined properties in the database 130. As such, the physical movement of a hardware controller is linked via a MIDI signal on a USB bus to a function that has been designated by a user during a learn process. The user defined function was stored in the database 130 and is used to prescribe how the MIDI signal is to link to the prescribed function.

Embodiments of the invention provide a very open, if not unlimited and flexible manner for an artist or user to control a few to literally thousands of parameters with an unnoticeable delay and ergonomic ease during a live performance. Each hardware controller 386 or live control object has a unique address within the exemplary device 100 such that the database 130 stores the address of the hardware controller or live control object and its association with the parameter, display control button, preset track, rack, signal chain, wet/dry, preset parameter or whatever the hardware or live control object is being linked to.

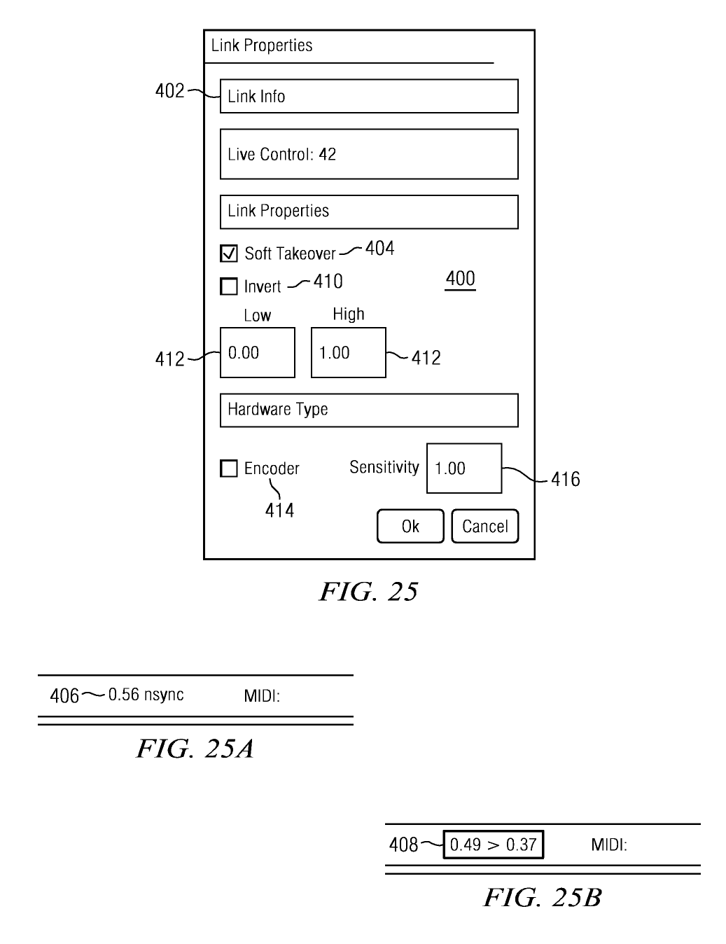

After a parameter has been bound or latched to a hardware or live control object, the user may select and right click the learned parameter, the link hardware button or the live control object to bring up a menu with learn, unlearn, and provide a graphical description on the display of the linked properties. An embodiment of a link properties display screen 400 is shown in FIG. 25. The link properties display screen provides the link information 402 by displaying which live control object and/or MIDI CC (hardware controller or associate MIDI address) to which the parameter is linked. The link properties display screen 400 may also allow the user to check a box indicating whether a host supported “soft take over function” 404 is to be utilized. The soft take over function 404 is valuable for when, for example, a first hardware controller is used to control a first parameter in a first selected preset. When a next song or preset is selected, that same hardware controller may have been learned and attached to a second parameter that has no relationship to the previously selected preset or the first parameter within the previously selected preset. Thus, when the song or preset is changed the user may not want to use the setting of the hardware control from the previous preset that uses the same hardware controller. Explained in other words, a hardware controller as linked to a first parameter in a first preset will be left in a random position when the user switches to another song or second preset that was the same hardware controller. The same hardware controller may be tied to or learned to a parameter associated with a plug-in the second preset. Without the soft take over function 404, if the hardware controller was moved during performance of the second preset, there may be a large jump in the parameter value from the parameter value that was stored in the database at the end of the last time the second preset was performed to the position of the hardware controller that is now being moved by the user during the present performance. Such a large parameter value change is very noticeable if the parameter is, for example, a volume or BPM parameter.

With soft take over, when the hardware controller is moved during the performance of the second preset or song, the value of the controlled parameter is not changed from its initial value until the (MIDI) value of the hardware controller or live object controller is equal to the stored initial (MIDI) value. In other words, the hardware or live object controller's data will not be utilized by the host software until it “over takes” or is momentarily equal to the previously stored value (initial value) of the parameter that the hardware controller is controlling.

In some embodiments, the host software will display on the graphic user display 120, in a predetermined location, such as the lower left of the screen, an indication as to whether the hardware controller being moved or adjusted by a user is in or out of sync state with the last stored value or user defined initial value for the parameter being controlled. FIG. 25A indicates an in sync indication 406 providing the value of the controlled parameter and that the hardware or live object controller are in sync with a, for example, user selected plug-in parameter such a knob or slider and thus, will move together when the hardware controller is moved by the user. FIG. 25B depicts an indication 408 that indicates that the hardware is out of sync with the preset or initial parameter value that is linked to. The difference between the plug-in parameter value and the hardware controller or live controller value is shown to aid the user in determining which way to move the hardware such that it will be in sync with the, for example, user selected plug-in parameter.

Referring back to FIG. 25, a user may select or deselect the invert function 410 on the link properties display screen 400. When selected, the invert function will invert the direction of the hardware control with respect to the value of the, for example, user selected plug-in parameter movement or value. Thus, moving the hardware or live object controller up will in turn be down or decrease the value and moving the hardware or live object controller left will be interpreted from a value perspective as moving it right.

The high and low values that have been set by the user are displayed in the high and low value boxes 412 as indicated in the link properties display screen 400.

When the encoder function is selected by the user on the link properties display screen 400, the selected control will behave like an encoder (i.e., behave as if there are no end-points on a, for example, knob). When the encoder function 415 is deselected, the control will behave like a potentiometer or slider and have end-points. Those end points are limited by maximum and minimum value as indicated by user selected low and high values as displayed in the high and low boxes 412. A user may also view and/or change the sensitivity value 416. The sensitivity value of a controller is indicative of how much and how quickly the knob, slider or other type of controller moves (how fast its value changes) and the ratios between the movements of the learned hardware controller or live object controller and the movements of the emulated physical knob, slider, or otherwise on the plug-in GUI display.

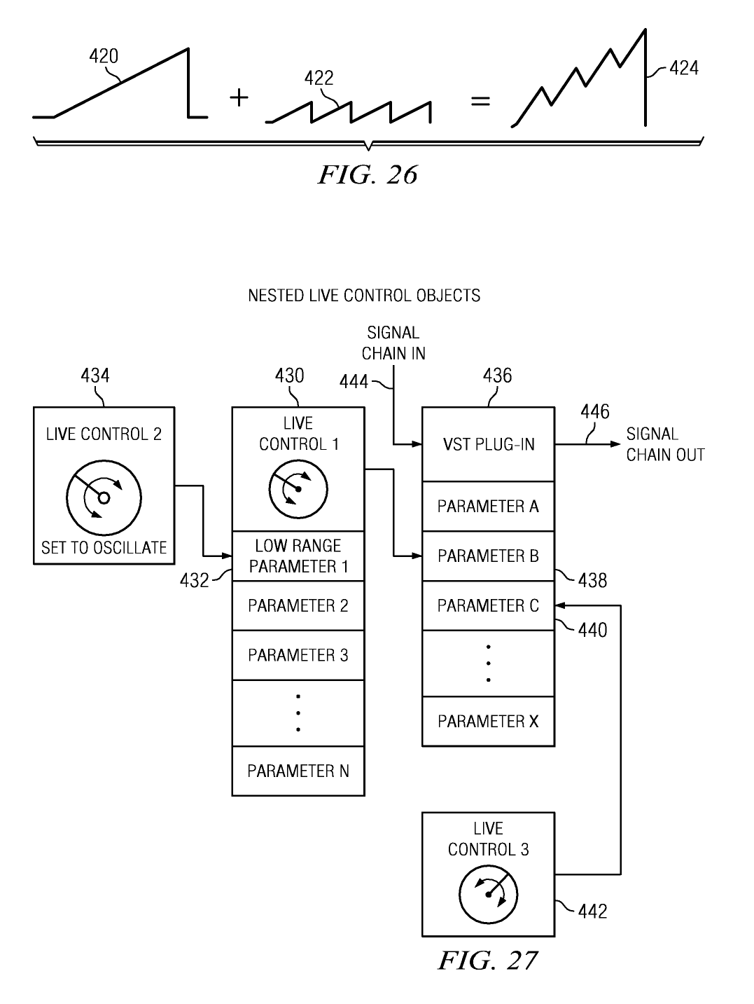

In another embodiment of the invention, a first live control object or a first hardware controller (a “first controller”) may be selected during learn mode to control additional live control objects in substantially any combination, layout or configuration in order to achieve a user-configured complex and compound control mechanism (“nested controls”) for use by a user during a live performance. A simple example of a combination or compound learning of previously learned live controls is depicted in FIG. 26 wherein a first live control object may be controlled by a saw-tooth oscillator having a first frequency 420. The output of the first live control 420 may be learned and linked to, and thereby modulate, a second live control 422, which may be controlled by a second saw-tooth oscillator having a second frequency. The resultant output of the second live controller 424, being a first saw-tooth frequency having the second saw-tooth frequency modulated thereon, may be utilized an output of the second controller or may be learned and attached such that the output 424 becomes the input of yet another live control object having yet another set of link properties. This combination of learning and linking multiple live control objects' outputs to additional live control objects may be referred to as nested controls. In yet another example of nested controls, an output sound of an instrument plug-in may be oscillated by a user-created first live control object with a sinusoidal waveform that varies the instrument volume output within user-defined ranges. The first live control object's output may then be learned and linked to a second user-defined live control object that allows a user to insert an amount of echo in the signal via a virtual knob or slider. The output of the echo knob or slider may be input into yet a third user-defined live control object, which modulates a signal with the BPM as determined by the host software or as set by the user. The output of this third live control object may be provided as a input signal to a VST effect plug-in where it is then acted on in accordance with the plug-in and its parameters along with an additional parameter that this user controlled by a fourth live control object having a preset oscillation thereby creating an unusual or new, yet repeatable, sound. Furthermore, the nesting of the live controls can be saved as a user-defined live control within the database 130 for use in other presets or song signal chains.

A novel song configuration sustain feature is also provided in some embodiments of the invention. The song configuration sustain feature is a functionality that enables a user to continue to hold a note/ivory key or notes played from a first or currently active song while the user selects a second/another song or preset 138 from the set list GUI 132. The sound generated at the signal chain output 200 (i.e., the MPS output 162) from holding the note or notes/ivory keys from the first song can be carried over and played until the user releases the associated ivory keyboard keys of the ivory keyboard interface 124. Additionally, the newly created sound(s) generated at the signal chain output 200 (i.e., the MPS output 162) for the second selected song can be played by the user while the ivory keys associated with the first song are held down. For example, the user can hold down the notes of an organ sound created in a song A configuration. These organ sound notes of song A may be played and held, for example, with the user's left hand fingers pressing one or more ivory keys of the ivory key interface 124. Meanwhile, the user may use his right hand to select a song B configuration (or preset) 138 on the set list GUI 132. The exemplary invention will respond to the song B selection and configure the MPS for the song B configuration and enable the user to play newly pressed notes/keys on the ivory keyboard interface 124 for song B with, for example, a bass sound. All the while, the held organ notes from the first/previous song A configuration are sustained until the user's left hand releases the held notes/keys.

The song configuration sustain feature can be provided by embodiments of the invention because, for example, when a set of songs or presets 138 are selected by a user to be included on the set list GUI 132, all the data and plug-ins associated with the selected songs or presets 132 in the selected set list or on the set list GUI 132 are loaded into the RAM 104 and/or cache memory (not specifically shown) from the plug-in library 118 and the data base(s) 130. Having this data and plug-in information all loaded and readily available to audio processing microprocessor and related computer/mother board circuitry 102 enables multiple and simultaneous song configurations of virtual instruments in embodiments of the invention. Multiple and simultaneously virtual song configurations allow embodiments of the invention to hold and sustain final notes or sounds from a first song configuration and simultaneously configure the track and rack plug-in signal chains for a user selected second song configuration. As such, a user can sustain sounds from the end of a first song and smoothly overlap new sounds created at the beginning of a second song without having to wait for the exemplary MPS to upload or configure data and plug-ins for the second song. This song configuration sustain feature allows a user, in a live performance, to not only switch from one preloaded virtual instrument to another quickly, but more over, to sustain the sounds of a first entire song configuration while switching to an entirely different second song configuration and begin playing virtual instruments of the second song configuration on the same ivory keyboard after pressing a single song or preset button 138 on the set list GUI screen 132.

FIG. 27 depicts a method and embodiment of using and creating nested live controls in the signal chain. The nesting of live control objects incorporates the learning and latching of a live control object or hardware control object to a control button, parameter or otherwise as discussed above with respect to FIG. 23. Live control nesting should be understood as creating virtual controllers or live control objects that control other live control objects. Nesting can be utilized for, among other things, to create time-based effects, to incorporate a user controlled variable in the modulation of a signal, produce a virtual live controller that oscillates itself with a user-defined oscillating wave frequency, and/or use a self-oscillating or user-controlled oscillating live control to control one or more parameters of a plug-in to thereby modify and act on a signal within a signal chain. This may be used to create repetitive sounds that may be modified by the user but may not be physically repeatable on an ongoing basis by the moving of a user on a physical instrument control or actual instrument otherwise.

Referring to FIG. 27, the live control object 430 has a parameter 1 432 that can be changed to set the low range 432. A second live controller 434 may be learned and latched to the low range parameter 1 432 of a first live controller 430. The second live control 434 may be set to an oscillation frequency or type of oscillation that is very difficult for a user to perform with their hands such as a square wave, sin wave or saw-tooth wave form. A VST plug-in 436 comprises a plurality of parameters and may have two of its parameters, for example, parameter B 438 and parameter C 440, learned and attached to the output of the first live controller 430, and to a third live controller 442, respectively. Thus, a parameter, for example, volume for parameter B 438, may be adjusted by nested live controllers wherein live controllers 1 430 and 2 434 may operate without continuous user input in that the user may set live control 2 434 to oscillate at a frequency with its output oscillated by live control 1 430 at another frequency without continuous input from the user during a live performance. Meanwhile, live control 3 442 may control the echo parameter of the VST plug-in 436 and the user may set it to automatically adjust at a user-defined oscillation frequency or waveform or allow the echo to be under user control during the live performance. As such, one can comprehend the versatility and near infinite combinations and permutations of music sounds and effects that can be acted on and/or generated by embodiments of the invention in or for a live setting based on a created and saved database 130 having associated therewith a track, rack, sound, and effect signal chain stored therein. The signal chain going into the VST plug-in 436 (or any other controllable element) is thereby effected by the parameter variations of parameter B 438 and parameter C 440 to produce the signal chain output 446 of the particular VST plug-in 436. The signal chain out 446 may continue in the signal chain path within an exemplary embodiment or be utilized as the overall device output 162 of the exemplary embodiment to be provided to the sound system and/or speakers. It should be further understood that there may be a plurality of outputs other than output 162, which may also be provided to, for example, the MIDI I/O 126 via USB bus to an external audio related device such as to a lighting system, fog system, video system or other sound effect device external to an exemplary MPS 100.

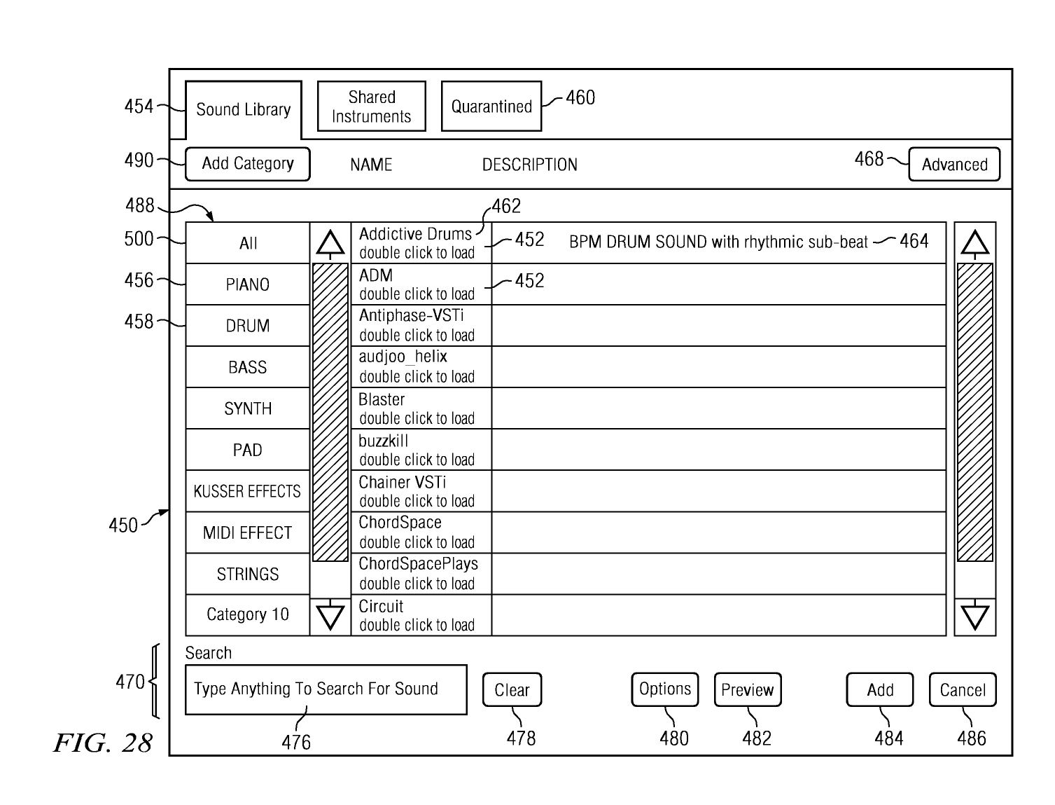

FIG. 28 depicts an exemplary sound browser display screen, which may be displayed on the graphic user interface and display screen 120. The sound browser display screen 201 provides a, organized display from which a user may select a plug-in from the plug-in library 118 or from a plug-in created and stored previously with a user defined name. The types of plug-ins that may be selected comprise instrument plug-ins, effects plug-ins, MIDI VSTs plug-ins, DirectX, APIs, Ails or shared plug-ins. The sound browser screen 450 may be accessed by the user, via the host software, from the setlist screen 132 or from its signal chain screen 180 by clicking on an empty slot in the instrument rack, signal chain or by selecting one of the add effect/instrument buttons. All of the dynamic links 452 displayed on the sound library display screen 450 represent plug-ins that can be or have been loaded into RAM 104 from the plug-in library 118 along with associated database folders containing user selected options-information as would be displayed in the options menu. Plug-ins that have not been loaded for an active preset or setlist can be made available to load from the plug-in library can be viewed via selection of the sound library tab 454 or by double clicking one of the category control buttons such as piano 456 or drum 458. The host software 112 will display the sound browser display 450 with the sound browser library tab 454 as the default screen when first opened. If, for some reason, a plug-in via a dynamic link 452 does not load from the plug-in library 118 correctly or has other problems operating, it will be placed by the host software in a quarantine database file, which can be viewed by selecting the quarantined tab 460. Plug-ins that have been placed in the quarantine database file can be viewed by selecting the quarantine tab 460. They can no longer be opened, loaded, or used in any capacity until the user attempts to manually unquarantine the plug-in by right-clicking the plug-in entry and attempting the unquarantine function. If successful, the plug-in will be removed from the quarantine list and be available to be loaded via normal means.

The sound library display screen 450 displays the name of each plug-in 462 along with a user defined description 464. The name or list of plug-ins may be sorted alphabetically and further may be separated by categories, such as piano, drums, bass, synth, MIDI effects, strings, etc.

In an embodiment of the invention, when a user right clicks on the plug-in list menu a drop down menu screen appears a right click plug-in menu appears which may comprise one or more of the following functions:
a. Unquarantine—Selection of unquarantine from the plug-in right click menu may only occur when the quarantine tab 460 has been selected. Most plug-ins that are placed in the quarantine tab's related database are there due to not being able to load correctly or some other error or fault that occurs when they are used with the host software. If a user wants to unquarantine a quarantined plug-in, the plug-in must first be reloaded and scanned by the operating system and/or the host software. Before rescanning a newly loaded plug-in, a user may be asked by the host software to confirm that they want to perform this task. The user may be warned by the host software that a malfunctioning plug-in may cause the host software to crash. If the newly loaded and or rescanned plug-in fails the scan, then the host software will not allow the quarantined plug-in to be removed from the quarantine tab database as it will not be considered operationally safe for the host software to use it.
b. Set Description—Selection of set description from the plug-in list right click menu by a user directs the host software to allow a user to enter the description, for example, description 464 of the selected plug-in, by launching a rename dialog module for the user to interact with.
c. Quarantine—Selection of the quarantine item by a user on the plug-in list right click menu takes a user selected plug-in out of its category group and places it into the quarantine tab database group.

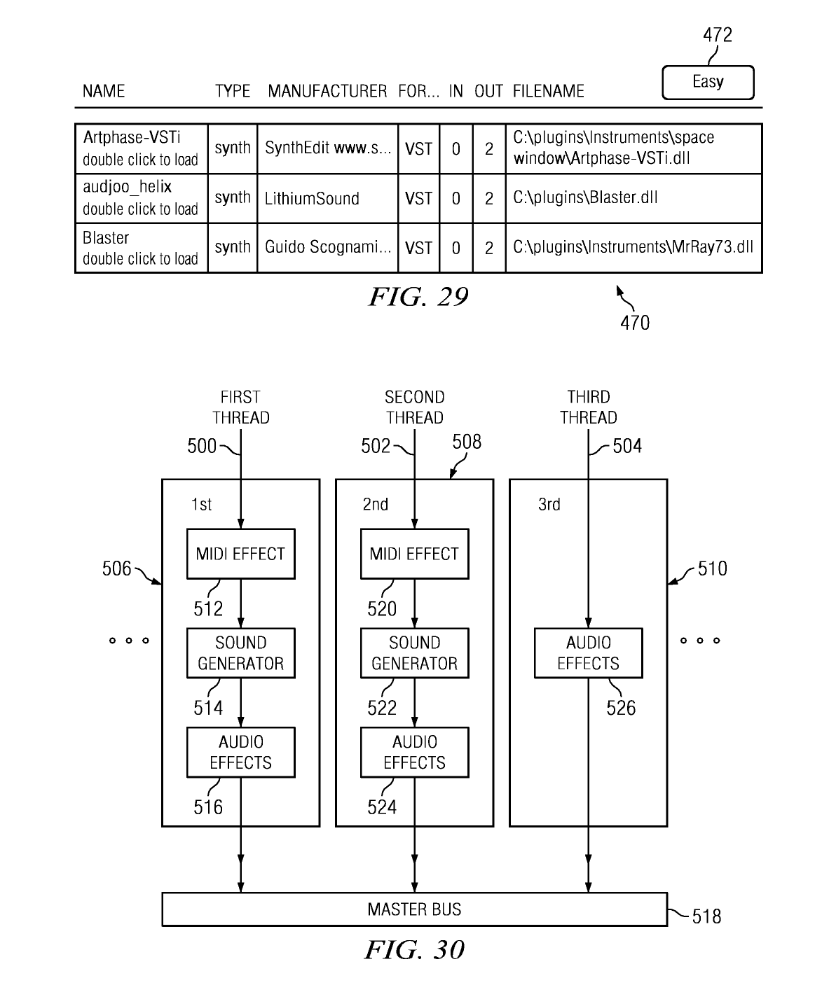

Referring to FIGS. 28 and 29, selection of the advanced control button 468 by a user provides a more detailed sound library display screen 470, a portion of which is shown in FIG. 29. The advanced display screen 470 may list more detailed low level information about each plug-in. Including the type of plug-in, the manufacturer of the plug-in, the format of the plug-in and the file name of the plug-in, just to name a few items. Selection of the easy control button 472 by a user switches the advanced sound library display screen 470 back to the normal sound library display screen 450. Each column of the advanced sound library display screen 470 may be sorted in ascending or descending order by selecting the column title (example, type, manufacture, format, etc.) at the top of each column. The advanced sound library display screen 470 may comprise columns containing one or more of the following types of information:
a. Name—Name of the plug-in.
b. Type—The indication of the type of plug-in derived from its inputs and outputs (MIDI and audio).
c. Manufacturer—The registered manufacturer of the plug-in.
d. Format—The type of format that the plug-in has been programmed in (e.g., VST, DX, etc.)
e. In—The audio input count.
f. Out—The audio output count.
g. MIDI In—The MIDI input count.
h. MIDI Out—The MIDI output count.
i. File Name—The full path and file name of the plug-in.

A sound library display screen 450 may include some standard host controls on for example, the bottom portion 474, or elsewhere on the screen. These controls may include, but are not restricted to, a search field area 476 wherein the user may enter text for searching through the entire sound library. Upon entry of text by a user, the host software would search the text fields of the various plug-ins for matching or similar character strings. The results of the search may appear immediately in the main window area of the sound library display screen 450. A clear control button 478 may be provided to clear the search field 476 and revert to the main view of the exemplary sound library display screen 450 to a listing of all of the plug-ins in the category selected. User selection of the options control button 480 opens the option dialog screen for the selected plug-in on the sound library display screen 450. Selection of the preview button 482 instructs the host to provide a preview of the selected plug-in. For an instrument plug-in, the first preset would be loaded and playable from the MIDI keyboard. For effect plug-ins, the sound would be routed through the default presets of the selected effect. Selection of the add control button 484 selects and adds the current plug-in for use and user modification of its parameters in the active signal chain. Finally, the cancel control button 486 cancels the add an additional plug-in operation such that nothing is added to the active signal chain.

The category control column 488 of the sound library display screen 450 allows a user to sort all of the plug-ins in easy to understand categories, such as the piano category 456 or plug-ins of the drum category 458. The host software may be supplied with all of the plug-ins from the plug-in library in a presorted manner, but the host software user can also rename and or create new categories for modified and or user created plug-in variants. User selection of the add category control button 490 instructs the host software to add a new category that can be named or titled by the user. A user may add selected plug-ins to any such category by dragging a plug-in from the plug-in list and dropping them into the category control button, such as the drum category control button 458 or any other category that the user wants. The host software allows a user to move the same plug-in into one or multiple different categories. Right clicking on an item on any category control button, except the all category control button 500, will bring up a menu that includes an option to remove a particular plug-in from a selected category. Removal of a plug-in from a category will not remove the plug-in from the all 500 category. The categories created originally in the host software or additional categories created by the user are the ones that display as choices for the user on the setlist and signal chain display screens. Plug-ins in a category may be moved around to adjust their order and how they are displayed if alphabetical order is not desired.

Referring now to FIG. 30, a flow diagram of a plurality of signal chains is shown. For example, a first data signal thread 500 proceeds through a first signal chain; a second signal data thread 502 proceeds through a second signal chain; and a third data signal thread proceeds through a third signal chain. In multi-core processing, the signal chains can be threaded through the multi-core processor thereby creating a pseudo parallel processing environment. The host software provides the first second and third data threads 500, 502, 504 for each of the signal chains 506, 508, 510 respectively. The operating system divides the data threads for processing by the multiple cores of the microprocessor 102. For example, if the microprocessor is a 3 core microprocessor the operating system may divide the three data threads 500, 502, 504 such that each core of the processor processes the data threads in a substantially parallel processing manner. Alternatively, if there are only two cores in the microprocessor, then the operating system will load balance the plurality of data threads 500, 502, 504 to minimize the delay of any one particular data thread. The first data thread 500 may represent a signal chain where the MIDI effect is an output of an ivory keyboard 512. The output of the MIDI effect ivory keyboard 512 is then processed via the core of a microprocessor utilizing the host software and the appropriate sound generator plug-in at 514. The processor continues with the first data thread by applying the one or more audio effects in the signal chain 516 and buffering the digital output prior to placing it on the master bus 518. Simultaneously, a second data thread 502 is being processed through the second signal chain 508, wherein the MIDI effect therein may be a set of MIDI drum pads with acceleration 520. The second core of the microprocessor continues processing the second thread 502 as the appropriate drum sound generator plug-in 522 is applied using both the host software and the drum sound generator plug-in 522. The output is processed in the second core through various user selected audio effects 524 to thereby produce a drum output, which is buffered prior to being applied to the master bus 518 in conjunction with the processed first thread. Still in a parallel manner, a third data thread 504, which may originate from the pickups of a electrical guitar or other external audio device 114 (see FIG. 1), is provided to an audio I/O input of an exemplary music production system 100 and provided as the third thread 504. User selected plug-in audio effects 526 such as reverb and echo may be sent by a third core of the microprocessor to the third data thread 504 producing a digital buffered output that will be sent to the master bus 518. The operating system 110 load balances the various cores of a microprocessor and related computer electronics 102 and may time stamp the data flow through the various cores of the microprocessor such that the data signal threads are aligned in a correct time relationship time on the master bus for transformation into an audio output 162 of an exemplary embodiment. The parallel processing and or load balancing of various data signal threads associated with the plurality of signal chains utilized in a preset during a live performance is critical to a timing and synchronization of the plurality of signal chains being output in time-synced unison thereby producing optimal fidelity of the various tracks within each preset during a live performance. A delay of any particular signal chain during a live performance will produce a noticeably distracting, unplanned and perhaps off BPM sound thereby degrading the quality of the output of an embodiment of the invention. As technology advances the number of cores within a microprocessor and the processing speed of a microprocessor, the number of signal chains or tracks within a particular preset will increase such that the number of tracks can go from for example eight tracks per preset, to hundreds of tracks per preset such that embodiments of the invention could handle an entire electronic orchestra encompassing hundreds of simultaneously played hardware or plug-in instruments each having their own signal chain with sound plug-ins and multiple effects applied thereon.

It will be appreciated by those skilled in the art having the benefit of this disclosure that embodiments of the herein described universal music production system provides a means for the control of audio synthesizers and processors in a live environment. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

What is claimed is:

1. A music production system comprising:
a Graphic User Interface (GUI) display;
data processing circuitry comprising a microprocessor, the data processing circuitry adapted to be electronically coupled to the graphic user display;
an input device adapted to be electronically coupled to the data processing circuitry;
memory storage electronically coupled to the data processing circuitry, the memory storage comprising a host software, a plurality of plug-ins, and a database;
a plurality of instructions wherein at least a portion of the plurality of instructions are storable in the memory storage as part of the host program and the plurality of plug-ins, and further wherein the plurality of instructions are configured to cause the data processing circuitry to perform:
responding to a user selectable live mode/edit mode control button by setting the music production system to operate in a live mode or in an edit mode;
if the music production system is set to operate in the edit mode, then accepting user input, via the input device, to edit a set list, edit a preset, edit a track, edit a rack, select or deselect a plug-in, adjust parameters of a selected plug-in or GUI control button, edit a signal chain, create a live control object, or learn a user selected parameter to a user selected hardware controller or a user selected live control object;
if the music production system is set in the live mode, then accepting user input, via the input device to initiate or adjust a live mode function, and not accepting or enabling user input that causes the data processing circuitry to perform a plurality of predetermined functions that are available in the edit mode.

2. The music production system of claim 1, wherein the plurality of predetermined functions comprise at least one of a set list add/delete, a preset add/delete, a track add/delete, a rack add/delete, a plug-in add/delete, a plug-in add/delete, a signal chain add/delete or a live control object add/delete.

3. The music production system of claim 1, wherein the input device comprises at least one of a touch sensitive surface on the GUI display, a keyboard, a pointer device, and the user selected hardware controller.

4. The music production system of claim 1, wherein if the music production system is set in the edit mode and wherein the plurality of instructions are further configured to cause the data processing circuitry to perform a learn operation, wherein the learn operation comprises:
responding to the user selecting of a learn control button (or to the user performing an operation equivalent to selecting the learn control button) by placing the music production system in a learn mode:
highlighting a first user selected parameter;
receiving a Musical Instrument Digital Interface (MIDI) Controller Command (CC) as a result of user initiated movement of a first selected hardware controller or virtual movement of a first selected live control object;
latching changes in a value of the user selected parameter to a user position or movement change of the first selected hardware controller or a user selection or virtual position change of the first selected live control object; and
providing a visual indication that the selected parameter is learned to the first selected hardware controller or learned to the first selected live control object.

5. The music production system of claim 4, wherein the host software recognizes each hardware controller by a different MIDI CC number and each live control object by a different live control/MIDI CC number.

6. The music production system of claim 4, wherein the learn operation further comprises nesting learned live control objects, wherein nesting learned live control objects comprises:
responding to the user selecting the learn control button (or to the user performing an operation equivalent to selecting the learn control button) by placing the music production system in learn mode;
highlighting a first user selected live object parameter associated with the first selected live control object;
receiving, from a second live control object, a second MIDI CC as a result of the user initiated selection or virtual movement of the second live control object; and
latching changes in the value of the first live object parameter to the virtual movement or position of the second live control object.

7. The music production system of claim 6, wherein the user specified movement of the second live control object comprises user defined automated movements having user selectable maximum, minimum, oscillation type and frequency characteristics.

8. The music production system of claim 1, wherein if the music production system is set to operate in the live mode and wherein the plurality of instructions are further configured to cause the data processing circuitry to perform a soft takeover operation, wherein the soft takeover operation comprises:
responding to the user's selection of a first preset by configuring a first track, a first rack, a first plug-in, a first signal chain and a first hardware controller that is learned to a first parameter of the first plug-in in accordance with first preset data stored in the database;
comparing a representation of an initial setting of the first parameter with a representation of a physical position of the first hardware controller;
disallowing signals received from the first hardware controller to adjust the first parameter until after the first hardware controller is moved such that the representation of the physical position of the first hardware controller is momentarily equal to the initial setting of the first parameter.

9. The music production system of claim 1, wherein the plurality of instructions are further configured to cause the data processing circuitry to perform:
displaying a set list GUI on the GUI display, the set list GUI comprising a plurality of song or preset buttons wherein each song or preset button represents a different, user configured, song or preset configuration;
loading database data and plug-in information for each of the user configured song or preset configuration displayed on the set list GUI, the database data and plug-in information being loaded from the memory storage to a Random Access Memory (RAM), which is in electronic communication with the data processing circuitry;
responding to a first user selected song or preset selection by configuring the first user selected song or preset selection;
processing a first user generated MIDI signal associated with the first user selected song or preset;
responding to a second user selected song or preset selection by configuring the second user selected song or preset selection;
continuing to process the first user generated MIDI signal for as long as the first user generated MIDI signal is held by the user;
processing a second user generated MIDI signal associated with the second user selected song or preset simultaneously with the processing of the held first user generated MIDI signal.

10. The music production system of claim 9, wherein the database further comprises a learned parameter and live control object relationship data associated with one of a first preset data's associated track data, rack data, sound plug-in data or effect plug-in data.

11. The music production system of claim 9, wherein the database further comprises a learned parameter and hardware controller relationship data associated with one of a first preset data's associated track data, rack data, sound plug-in data or effect plug-in data.

12. A music production system comprising:
data processing circuitry comprising a microprocessor, the data processing circuitry adapted to be electronically coupled to a graphic user display;
an input device adapted to be electronically coupled to the data processing circuitry;
memory storage electronically coupled to the data processing circuitry, the memory storage comprising a host software, a plurality of plug-ins, and a database;
a plurality of instructions wherein at least a portion of the plurality of instructions are storable in the memory storage as part of the host program and the plurality of plug-ins, and further wherein the plurality of instructions are configured to cause the data processing circuitry to perform:
configuring a user's selection of a first plug-in and request to add the first plug-in to a virtual signal chain of a user selected first preset;
configuring the user's selection of a second plug-in and request to add the second plug-in in the virtual signal chain after the first plug-in;
determining, by the host software, whether the order of the first plug-in and the second plug-in in the virtual signal chain is an illogical configuration of plug-ins in the virtual signal chain;
informing the user, via a GUI screen, when the order of the first plug-in and the second-plug-in will not be operational in the music production system.

13. The music production system of claim 12, wherein informing the user comprises not enabling the user to virtually add the second plug-in after the first plug-in the virtual signal chain.

14. The music production system of claim 12, wherein determining further comprises checking whether a sound plug-in is illogically placed in the virtual signal chain after an effect plug-in.

15. An article of manufacture for a music production system, the article of manufacturing comprising:
a computer readable medium;
a plurality of instructions wherein at least a portion of the plurality of instructions are storable in the computer readable medium, and further wherein the plurality of instructions are configured to cause a processor to perform the steps of:
responding to a user's selection of placing the processor in a live mode or edit mode;
if the music production system is set by the user to operate in the edit mode, then accepting user input directing the plurality of instructions to edit a set list, edit a preset, edit a track, edit a rack, select or deselect a plug-in, adjust parameters of a selected plug-in or GUI control button, edit a signal chain, create a live control object, or learn a user selected parameter to a user selected hardware controller or user selected live control object;
if the music production system is set in live mode, then accepting user input via one or more predetermined input devices and using the user input to adjust a live mode function and not accepting or providing a means for the user to input instructions that may cause the processor to perform a set list add/delete, a preset add/delete, a track add/delete, a rack add/delete, a plug-in add/delete, a plug-in add/delete, a signal chain add/delete or a live control object add/delete.

16. The article of manufacture of claim 15, wherein the one or more predetermined input devices comprise at least one of a touch sensitive GUI display screen, a keyboard, and ivory keyboard, and a hardware controller.

17. The article of manufacture of claim 16, wherein the plurality of instructions provide virtual signal connectivity between a user defined virtual MIDI live control object displayed on the touch sensitive GUI screen and a virtual digital audio plug-in configured by the user to be in a virtual signal chain.
